(19) United States
(12) Patent Application Publication
(10) Pub. No.: US 2010/0028554 A1
(43) Pub. Date: Feb. 4, 2010

(54) METHOD FOR MANUFACTURING EMBOSSED SHEET AND APPARATUS THEREFORE, METHOD FOR MANUFACTURING PATTERNED SHEET, AND PATTERNED SHEET

(75) Inventors: Shotaro Ogawa, Fujinomiya-shi (JP); Junichi Fujimori, Fujinomiya-shi (JP)

Correspondence Address: BIRCH STEWART KOLASCH & BIRCH, PO BOX 747, FALLS CHURCH, VA, 22040-0747, US

(73) Assignee: FUJIFILM CORPORATION, Minato-ku, TOKYO (JP)

(21) Appl. No.: 12/067,438

(22) PCT Filed: Sep. 19, 2006
(86) PCT No.: PCT/JP2006/318895

§ 371 Date: Aug. 12, 2009

(30) Foreign Application Priority Data
Sep. 20, 2005 (JP) 2005-272387
Sep. 21, 2005 (JP) 2005-274126
Oct. 11, 2005 (JP) 2005-296452

(51) Int. Cl. C08F 2/46; B05D 3/00; B05D 5/06; B05C 11/02

(52) U.S. Cl. 427/487; 427/532; 427/278; 427/162; 118/44

(57) ABSTRACT

An embossed sheet, on which fine embossed patterns are regularly formed on a surface, is manufactured without any defects and with a high quality at a high line speed and at a high level of productivity. A method for manufacturing an embossed sheet, in which irregularities of a surface of an emboss roller is formed by transfer on a surface of a flexible strip-shaped sheet W. After coating a resin solution which is diluted with an organic solvent, the sheet on which a resin solution layer is formed on a surface is continuously run, the organic solvent contained in this resin solution layer is dried, the sheet after dried is wound around the emboss roller which is rotating, and irregularities of a surface of the emboss roller are transferred to the resin solution layer, and then the resin solution layer is cured, with the sheet being wound around the emboss roller.

### TECHNICAL FIELD

The present invention relates to a method for manufacturing an embossed sheet and an apparatus therefor and to a method for manufacturing a patterned sheet having a fine pattern, and in particular to a method for manufacturing an embossed sheet and an apparatus therefor which are favorable to manufacture a sheet-like material such as an embossed sheet, on which a fine embossed pattern is regularly formed so as to produce an antireflection effect and which has no flaws and thus has high quality, at a high line speed and with high productivity, and to a method for manufacturing a patterned sheet which is practically applied to a polarizing film, a biochip, a microsensor, a waveguide, a recording medium or the like.

### BACKGROUND ART

An embossed sheet having an antireflection effect has recently been adopted into a field of electronic displays such as liquid crystals. In addition, a flat lens such as a lenticular lens or a fly's eye lens, as well as an embossed sheet such as a light diffusion sheet, a luminance improving sheet, a light guide sheet, or a prism sheet have also been used. For these embossed sheets, a sheet on which fine embossed patterns are regularly formed has conventionally been well known to the public. As a procedure for regularly forming such fine embossed patterns, various kinds of methods have conventionally been known (see, Japanese Patent No. 2533379, Japanese Patent No. 2891344, Japanese Patent Laid-Open No. 11-300768, Japanese Patent Laid-Open No. 2000-141481, Japanese Patent Laid-Open No. 2002-333508, Japanese Patent No. 3218662, and Japanese Patent Laid-Open No. 2001-212900).

For example, it is disclosed that, in an apparatus having a structure as illustrated in FIG. 6, a surface of a stamper roller 1 on which embossed patterns are regularly formed is coated with resin using a coating device 2, and a sheet 3 which is continuously running is sandwiched between the stamper roller 1 and a nip roller 4, and then the resin is cured by applying electromagnetic radiations thereto while the resin on the stamper roller 1 is brought into contact with the sheet 3, and subsequently the sheet 3 is wound around a release roller 5 in order to release the sheet 3 from the stamper roller 1 (see, Japanese Patent No. 2533379, Japanese Patent No. 2891344, and Japanese Patent Laid-Open No. 11-300768).

In addition, it is also disclosed that, in an apparatus having a structure as illustrated in FIG. 7, a surface of a sheet 3 which is continuously running is previously coated with resin, and this sheet 3 is sandwiched between a stamper roller 1 on which embossed patterns are regularly formed and a nip roller 4, and then the resin is cured by applying electromagnetic radiations thereto while transferring the embossed patterns of the stamper roller 1 onto the resin, and subsequently the sheet 3 is wound around a release roller 5 in order to release the sheet 3 from the stamper roller 1 (see, Japanese Patent Laid-Open No. 11-300768, and Japanese Patent Laid-Open No. 2000-141481).

It has also been suggested some techniques for manufacturing a patterned sheet, on which embossed fine patterns are formed, by transferring the predetermined fine patterns which are formed on a mold for pattern transfer to the sheet.

For example, among such techniques is a method for manufacturing a patterned sheet in which the mold for pattern transfer is pressed against a substrate or a material coated on a surface of the substrate at a predetermined pressure while applying heat thereto, and then both the material and the die are cooled before releasing them from each other (a thermal imprint method). Further, there is also a method for manufacturing a patterned sheet in which a photo-curable resin is coated on a mold for pattern transfer or on a substrate, and then the mold for pattern transfer being overlaid on the substrate is exposed to light in order to cure the photo-curable resin before releasing the die and the material from each other (a photo imprint method). In addition, there is also a method for manufacturing a patterned sheet in which a mixed solution formed by dissolving a resin in a solvent is coated on a mold for pattern transfer, and then the mixed solution is dried before releasing the dried sheet from the mold for pattern transfer (a cast imprint method).

Recently, it has also been suggested a technique for forming a patterned sheet with a high aspect ratio, which is hard to be manufactured. For example, Japanese Patent Laid-Open No. 2004-288783 suggests a procedure for forming a pattern (pillar) with a high aspect ratio, which is resulted from coating a release agent only on a salient of a stamper (a die) and then extending the pattern (pillar portion) at a time of releasing. In addition, Japanese Patent Laid-Open No. 2005-53198 suggests a procedure for forming a patterned sheet with a high aspect ratio, in which a surface of a transferring die made of a hydrophilic Si substrate (a silicon substrate) is coated with a resin, and then the resin is solidified before releasing the resin from the die by dipping the transferring die, on which the resin is coated, into hot water for example.

### DISCLOSURE OF THE INVENTION

However, the problem is that, when a line speed is increased in order to improve productivity, coating streaks are produced and a resin solution can not sufficiently be wet or spread on a surface of a roller, so that it is difficult to uniformly form a layer of the resin solution.

In addition, optical resin layers have recently been required to have a higher refractive index, because of its optical design. As for a Fresnel lens for example, the higher the refractive index of the optical resin layer, the shallower the lens pattern can be made. This provides an advantage that it becomes easy to release from the die, so that the productivity can be improved.

Further, in the case of a prism sheet for improving front brightness of a back light unit used for a liquid crystal display, the higher the refractive index of the optical resin layer, the higher the front brightness, when the sheet is designed such that the prisms have identical apex angles.

On the other hand, in order to achieve high refractive indices of such optical resin layers, compounds which sufficiently contain aromatic ring structures or halogen compounds such as bromine are required to be used as curable compositions. However, such compounds are generally in the form of high viscosity liquid or solid. This provides a resin solution with high viscosity, so that there is a problem that coating properties become worse compared with the case of manufacturing by the above described method, and consequently it is difficult to increase the line speed and to improve the productivity.

However, there is also a problem that, when transferring patterns have fine or complicated shapes, a sheet after curing the resin is significantly difficult to be released from the stamper roller without any flaws. The insufficient release as described above may lead not only to sheet flaws, but also to residue of cured resin debris generated on a surface of the emboss roller, and thus generated residue may further facilitate development of flaws.

In order to solve these problems, the cured resin and a pattern surface of the roller are required to have sufficient releasability. Contemplated methods for solving such problems are: (a) use of a cured resin which is easy to be released; (b) use of a releasable material as a surface of the roller; and the like.

Among these means, (a) requires to previously add in the cured resin an additive for facilitating the release, which therefore leads to an increase in material cost and to a decrease in performance (for example, decrease in optical property such as transparency or refractive index).

On the other hand, (b) requires a releasing treatment of the roller surface. This has a disadvantage that the releasing treatment has to be performed intermittently with this line shut down several times, because effectiveness of the releasing treatment is gradually reduced as the production continues for a long time.

In addition, some of the above described patent documents address these problems. Japanese Patent No. 2891344 describes irradiation which is immediately performed before and after the release treatment when a substrate is released from an emboss roller. However, effectiveness of this irradiation is not clear. Japanese Laid-Open No. 2001-212900 describes that releasability is imparted to a cured resin material. However, this has a problem that freedom of choice of materials is restricted.

Further, when the above described thermal imprint, photo imprint, or cast imprint method is employed, it becomes harder to release a material under transfer such as resin, with increase in an aspect ratio of a patterned sheet. For example, a portion of the material under transfer may be broken off and thus remain on a mold for pattern transfer at a time of releasing the material under transfer. In particular, a structure with a high aspect ratio tends to exert a large stress on a resin due to friction between the mold for pattern transfer and the material under transfer, because of the increase in a contact area between the mold for pattern transfer and the material tinder transfer. Therefore, a patterned portion of the material under transfer may be broken at a time of releasing, and thus the resin may remain on the mold for pattern transfer. This results in defects of the patterned sheet to be manufactured, and thus defective patterned sheets may be repeatedly manufactured if the pattern transfer is repeatedly performed on the material under transfer.

In order to prevent the material under transfer from remaining as described above, some efforts have been made such as by performing a release treatment on a surface of the mold for pattern transfer or by adding a component for improving releasability to the material under transfer, for example. However, in the case of using a mold for pattern transfer on which a release treatment is performed, releasing performance is gradually reduced as the pattern transfer against the resin or the like is repeated. Therefore, it is necessary to periodically perform the release treatment on the mold for pattern transfer, in order to maintain favorable release performance. In addition, if a component for improving the release performance is added to the material under transfer, developing or choosing materials is less flexible since available materials are inevitably restricted.

On the other hand, when a procedure suggested in the above described Japanese Patent Laid-Open No. 2004-288783 is employed, it is very difficult to derive conditions of forming a uniform patterned sheet while maintaining favorable reproducibility. Available materials or patterning forms are also restricted.

In a procedure suggested in the above described Japanese Patent Laid-Open No. 2005-53198, a resin after being solidified is released from a transferring die. Thus, stress concentration is developed at a time of releasing, so that a portion of the pattern tends to be broken.

The present invention is provided in view of such circumstances, and an object of the present invention is to provide a method for manufacturing an embossed sheet and an apparatus therefor, which are favorable for manufacturing an embossed sheet on which fine embossed patterns are regularly formed without any flaws and with high quality at a high line speed and at a high level of productivity, and another object is to suggest a technique about a method for manufacturing a patterned sheet which is excellent in transfer stability and in mass productivity. In addition, another object of the present invention is to provide a technique which can stably manufacture a patterned sheet having a high aspect ratio.

In order to achieve the above described objects, the present invention provides a method for manufacturing an embossed sheet, in which irregularities on a surface of an emboss roller are formed by transfer on a surface of a sheet-like material, characterized by: continuously running a flexible strip-shaped sheet-like material, on which a resin solution layer is formed by coating the material with a resin solution which is diluted with an organic solvent; evaporating the organic solvent which is contained in the resin solution layer; winding the sheet-like material after dried around the emboss roller which is rotating, and then transferring the irregularities of the surface of the emboss roller to the resin solution layer; and curing the resin solution layer while the sheet-like material is wound around the emboss roller.

In addition, the present invention provides an apparatus for manufacturing an embossed sheet characterized by comprising: sheet-like material feeding device for feeding a flexible strip-shaped sheet-like material; a coating device for coating a surface of the sheet-like material with a resin solution which is diluted with an organic solvent; drying device for evaporating the organic solvent contained in the resin solution layer; transferring device for forming by transfer irregularities of a surface of the emboss roller on a surface of the sheet-like material, while winding the sheet-like material which is continuously running around the emboss roller which is rotating; and resin solution curing device for curing the resin solution while the sheet-like material is wound around the emboss roller.

According to the present invention, the resin solution can be diluted with the organic solvent to a desirably low viscosity such that wettability is improved, and also the volume of the coating solution can be increased by the organic solvent used for the dilution, and therefore the resin solution layer can be uniformly formed on the sheet-like material without any plane defects such as coating streaks or bubble failures even if the line speed is increased.

Since a step of evaporating the organic solvent contained in the resin solution layer is provided before curing the resin solution layer with the sheet-like material being wound around the emboss roller, there is no worry about deterioration in performance of the product or in strength of the cured layer which may be caused by residues of the added organic solvent remaining after curing the resin solution layer. Similarly, there is no worry that the organic solvent could be released during use of the product and then emit offensive odor or adversely affect our health.

In addition, although a uniform lens having a constant thickness may not be formed because the lens thickness (resin thickness) is hard to be controlled when a viscosity of the resin solution is too low at a time of winding the sheet-like material around the emboss roller for embossing, there is no worry about such a problem because the resin solution has a sufficient viscosity which is obtained by evaporating and removing the organic solvent at the time of embossing, as described above.

In this context, the term “an emboss roller(s)” is intended to include not only an emboss roller in which irregular patterns (for an emboss shape) are formed on a surface of a cylindrical roller, but also a roller in which irregular patterns (emboss shape) are formed on a surface of a belt-like material such as an endless belt. This is because even the belt-like material can act like the cylindrical emboss roller, and the same effects as the cylindrical emboss roller can be produced.

In the present invention, the above described resin solution is a radiation curable resin solution, and preferably a cure treatment of the resin solution layer is performed by exposing the resin solution layer to a radiation. Use of the radiation curable resin solution as described above facilitates the cure treatment of the resin. The details of the radiation curable resin will be fully described later.

In the present invention, the above described resin solution preferably contains 10% by weight or more of an organic solvent in order to decrease a liquid viscosity. Further, in the present invention, a viscosity of the resin solution at a time of coating is preferably 100 mPa·s or less. According to this resin solution which contains the organic solvent at the above described amount and has the above described low viscosity, a resin solution layer can uniformly be formed on a sheet-like material without any plane defects such as coating streaks or bubble failures.

In the present invention, coating of the above described resin solution is preferably performed by a die coater, a bar coater, a roll coater, or a gravure coater. These coating systems are favorable to coating of the present resin.

In the present invention, the above described resin solution preferably comprises at least (A) a compound containing a polymerizable group such as an acroyl group and/or a vinyl group, and (B) a compound which generates an active species capable of polymerizing the compound (A) by radiation exposure. Use of this radiation curable resin solution facilitates a cure treatment of the resin. The acroyl group is intended to include a methacroyl group as well.

In order to achieve the above described object, the present invention provides a method for manufacturing an embossed sheet in which irregularities on a surface of an emboss roller are formed by transfer on a surface of a sheet-like material, comprising the steps of: continuously running a flexible strip-shaped sheet-like material, on which a resin solution layer is formed by coating the material with a resin solution which is diluted with an organic solvent; winding the sheet-like material around the emboss roller which is rotating, and then transferring the irregularities formed on a surface of the emboss roller to the resin solution layer in which the organic solvent remains; and curing the resin solution layer with the sheet-like material being wound around the emboss roller.

For the above described purpose, the present invention provides an apparatus for manufacturing an embossed sheet, comprising: a sheet-like material feeding device for feeding a flexible strip-shaped sheet-like material; a coating device for coating a surface of the sheet-like material with a resin solution which is diluted with an organic solvent; a first drying device for evaporating the organic solvent contained in the resin solution layer; a transferring device for forming by transfer irregularities of a surface of the emboss roller on a surface of the sheet-like material, while winding the sheet-like material being continuously running around the emboss roller which is rotating; a resin solution curing device for curing the resin solution with the sheet-like material being wound around the emboss roller; and a second drying device for evaporating the organic solvent contained in the resin solution layer after being cured.

According to the present invention, a sheet-like material on which a resin solution layer diluted with an organic solvent is formed is wound around an emboss roller, and irregularities are transferred to the resin solution layer in which the organic solvent remains, and then the resin solution layer is cured as it is. At this point, the resin which has been cured with the solvent included has a better releasable property, and never develops defects which are due to release failure (the resin remains on a surface of the roller). In addition, inclusion of the solvent in a coating solution improves its wettability for a surface to be coated, and can also produce an effect of more stable coating.

Further, the resin solution can be diluted with the organic solvent to a desirably low viscosity such that wettability is improved, and also the volume of the coating solution can be increased by the organic solvent used for the dilution, therefore the resin solution layer can be uniformly formed on the sheet-like material without any plane defects such as coating streaks or bubble failures even if the line speed is increased.

According to the present invention as described above, an embossed sheet on which fine embossed patterns are regularly formed can be manufactured without any flaws and with high quality at a high line speed and at a high level of productivity.

In this context, the term “an emboss roller(s)” is intended to include not only an emboss roller in which irregular patterns (for an emboss shape) are formed on a surface of a cylindrical roller, but also a roller in which irregular patterns (emboss shape) are formed on a surface of a belt-like material such as an endless belt. This is because even the belt-like material can act like the cylindrical emboss roller, and the same effects as the cylindrical emboss roller can be produced.

In the present invention, the above described resin solution is a radiation curable resin solution, and preferably a cure treatment of the resin solution layer is performed by exposing the resin solution layer to a radiation. Use of the radiation curable resin solution as described above facilitates the cure treatment of the resin. The details of the radiation curable resin will be fully described later.

In the present invention, the above described resin solution layer is preferably cured such a state that the resin solution layer contains 1 to 10% by weight of the organic solvent. In such a situation that the resin solution layer as described above is cured, a release property becomes better.

Since deformation of the patterns appear due to evaporation and shrinkage when the concentration of the solvent is too high, the concentration of the solvent contained in the resin at a time of curing is preferably 1 to 10% by weight, and is more preferably 2 to 6% by weight. The concentration can also be adjusted within a drying apparatus, immediately before a transfer operation conducted by the emboss roller.

In the present invention, it is preferable that the concentration of the organic solvent is controlled by evaporating the organic solvent contained in the resin solution, before winding the sheet-like material around the emboss roller which is rotating. Provision of a step, in which the organic solvent contained in the resin solution layer is evaporated before winding the sheet-like material around the emboss roller so as to be cured as described above, eliminates worries about degradation of product performance and degradation of cured layer strength which are caused by residues of the added organic solvent after being cured. Similarly, there is no worry about emitting the organic solvent during use of the product, which may give off a bad smell or may adversely affect our health, as well.

In the present invention, it is preferable that the concentration of the organic solvent is controlled by evaporating the organic solvent contained in the resin solution, after releasing the sheet-like material from the emboss roller. Controlling the concentration of the organic solvent contained in the resin solution after releasing the sheet-like material from the emboss roller eliminates worries about degradation of product performance and degradation of cured layer strength which are caused by residues of the added organic solvent after being cured. Similarly, there is no worry about emitting the organic solvent during use of the product, which may give off a bad smell or may adversely affect our health, as well.

In the present invention, a pitch of an irregular pattern which is formed by transfer on the sheet-like material is preferably 100 μm or less. Further, in the present invention, the embossed sheet is preferably used as an optical film.

One aspect of the present invention relates to a method for manufacturing a patterned sheet which has fine patterns. The method for manufacturing the patterned sheet comprises the steps of: in a situation in which a transfer-receiving material containing an organic solvent and a resin polymer is interposed between a mold for pattern transfer having a predetermined pattern formed thereon and a substrate, bringing the mold for pattern transfer into close contact with the substrate via the transfer-receiving material; drying a portion of the organic solvent contained in the transfer-receiving material between the mold for pattern transfer and the substrate; and releasing a transferred film from the mold for pattern transfer, the transferred film being made of the transfer-receiving material on which fine patterns are formed by transferring the predetermined pattern of the mold for pattern transfer, and when the transferred film is released from the mold for pattern transfer, the transferred film which contains the organic solvent is released from the mold for pattern transfer.

According to this aspect, a transferred film containing the organic solvent is released from the mold for pattern transfer, so that the organic solvent acts as a lubricant and thus the transferred film becomes easy to slide from the mold for pattern transfer. Consequently, a stress exerted on the transferred film at a time of releasing is dispersed and a phenomenon of stress concentration is relieved, so that the transferred film becomes hard to be broken.

The term “organic solvent” described herein includes an organic solvent such as acetone. In addition, the term “resin polymer” includes a polymer such as an acrylic resin or a polystyrene resin.

When the transferred film is released from the mold for pattern transfer, the concentration of the organic solvent contained in the transferred film is preferably 5 to 40% by weight.

Specifically, the transferred film containing the organic solvent at such a level as described above can be released from the mold for pattern transfer in a good condition.

A polymer included in the substrate is preferably soluble in the organic solvent. In this case, a part of the substrate is solved in the organic solvent, and thus adhesiveness between the substrate and the transferred film is allowed to be improved so as to be able to favorably release the transferred film from the mold for pattern transfer.

It is preferable that the transfer-receiving material is interposed between the mold for pattern transfer and the substrate by coating the transfer-receiving material on at least one of the mold for pattern transfer and the substrate.

In this case, the transfer-receiving material can be interposed between the patter transferring die and the substrate with the high degree of accuracy and in an easy way.

In the method for manufacturing the above described patterned sheet in which the transfer-receiving material is interposed between the mold for pattern transfer and the substrate by coating the transfer-receiving material on the mold for pattern transfer, it is preferable that at least a periphery of an area on which the transfer-receiving material is coated among the mold for pattern transfer is depressurized when the transfer-receiving material is coated on the mold for pattern transfer.

In the method for manufacturing the above described patterned sheet in which the transfer-receiving material is interposed between the mold for pattern transfer and the substrate by coating the transfer-receiving material on the substrate, it is preferable that at least a periphery of the transfer-receiving material is depressurized when the mold for pattern transfer is brought into close contact with the substrate via the transfer-receiving material.

In the method for manufacturing the above described patterned sheet in which the transfer-receiving material is interposed between the mold for pattern transfer and the substrate by coating the transfer-receiving material on the substrate, it is preferable that the mold for pattern transfer is brought into close contact with the substrate via the transfer-receiving material while keeping them with a pressure applied thereon.

In these cases, providing a depressurized condition or a pressurized condition can prevent air or the like from penetrating into the transferring material. The phrase “while keeping them with a pressure applied thereon” referred herein means a case in which the mold for pattern transfer and the substrate are brought into close contact with each other and kept them as they are, for example.

In these cases, providing a depressurized condition can prevent air or the like from penetrating into the transfer-receiving material.

The above described mold for pattern transfer is preferably a Si workpiece which is derived from a Si substrate processed by using a mask and an etching treatment or a replica which is derived from the above described Si workpiece subjected to electroforming.

Making use of the above described mold for pattern transfer, fine patterns can accurately be formed on the transferred film, and then the transferred film can favorably be released from the mold for pattern transfer.

An aspect ratio of a salient of the fine pattern which is formed on the above described transferred film may also satisfy the relational expression: Height/Width ≧2.

Even in a case of such a high aspect ratio that the transferred film is hard to be released from the mold for pattern transfer, it is possible to favorably release the transferred film from the mold for pattern transfer.

An area ratio of a salient to a recess of the fine pattern formed on the transferred film may also satisfy the relational expression: an area of salient/an area of recess ≦0.5.

Even in a case such that an area ratio of the salient to the recess of the predetermined pattern transferred on the transferred film is hard to provide the release of the transferred film from the mold for pattern transfer, it is possible to favorably release the transferred film from the mold for pattern transfer.

A further aspect of the present invention relates to a patterned sheet which is manufactured in accordance with the above described method for manufacturing the patterned sheet.

According to this aspect, the patterned sheet is made of the pattern transfer-receiving material which has favorably been released from the mold for pattern transfer, and consequently a patterned sheet of a good quality is provided.

According to the present invention, as described above, an embossed sheet on which fine embossed patterns are regularly formed can be manufactured without any defects and with a high quality, at a high line speed and at a high level of productivity.

According to the present invention, a patterned sheet of a good quality is provided as well, because the transferred film can favorably be released from the mold for pattern transfer.

### BRIEF DESCRIPTION OF THE DRAWINGS

FIG. 1 is a conceptional diagram showing a configuration of an apparatus for manufacturing an embossed sheet applied to a first embodiment of the present invention;

FIG. 2 is a table showing the formulation of each resin solution in a first example;

FIG. 3 is a sectional view showing an outline of an emboss roller;

FIG. 4 is a table showing conditions and evaluation results of Examples and Comparative Examples in a first example;

FIG. 5 is a sectional view showing an outline of an embossed sheet;

FIG. 6 is a conceptional diagram showing a configuration of an apparatus for manufacturing an embossed sheet of a conventional example;

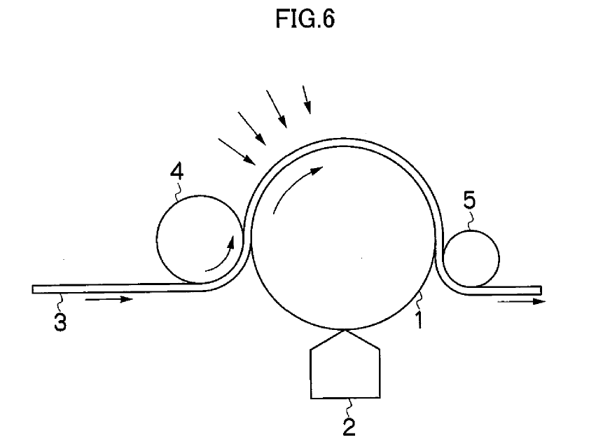

FIG. 7 is a conceptional diagram showing another configuration of an apparatus for manufacturing an embossed sheet of a conventional example;

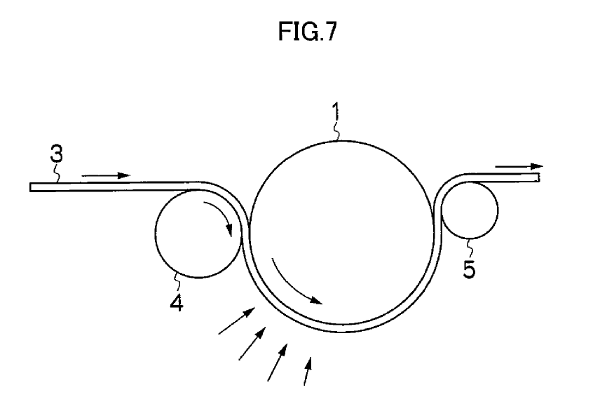

FIG. 8 is a table showing the formulation of each resin solution in a second example;

FIG. 9 is a table showing conditions and evaluation results of Examples and Comparative Examples in a second example;

FIG. 10 is a perspective view of a mold for pattern transfer in a second embodiment;

FIG. 11 is a sectional drawing of a mold for pattern transfer in a second embodiment;

FIGS. 12A to 12D are drawings showing a method for manufacturing a pattern sheet in a second embodiment;

FIG. 13 is a view showing an example of a patterned portion of a pattern-transferred film obtained by passing through a manufacturing process in FIGS. 12A to 12D; and

FIGS. 14A to 14D are views showing a method for manufacturing a pattern sheet in a third embodiment.

### DESCRIPTION OF REFERENCE NUMERAL

10 . . . apparatus for manufacturing embossed sheet, 11 . . . sheet-feeding device, 12 . . . coating device, 13 . . . emboss roller, 14 . . . nip roller, 15 . . . resin curing device, 16 . . . release roller, 17 . . . protective-film-feeding device, 18 . . . sheet-winding device, H . . . protective film, W . . . sheet

### BEST MODE FOR CARRYING OUT THE INVENTION

### First Embodiment

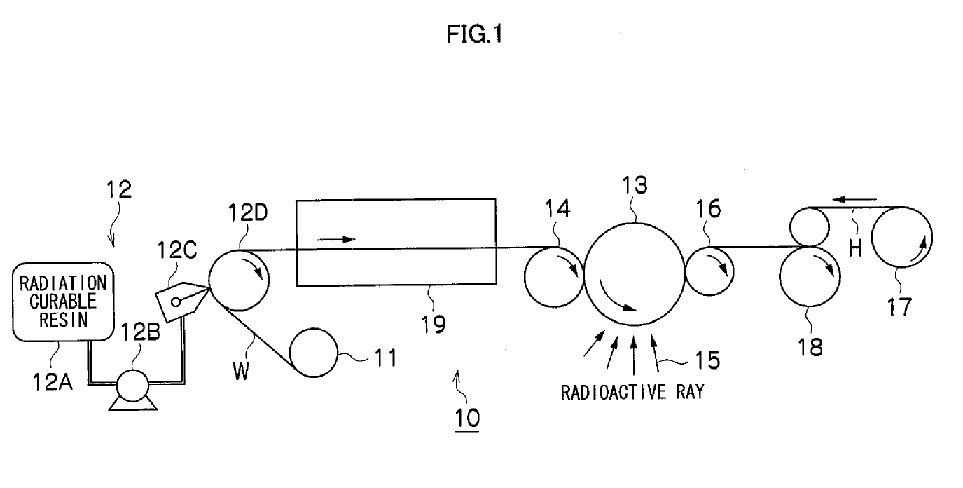

In the next place, a first embodiment according to the present invention will be described on the basis of attached drawings. FIG. 1 is a view showing a configuration of an apparatus 10 for manufacturing an embossed sheet, to which the present invention is applied.

The apparatus 10 for manufacturing the embossed sheet is composed of a sheet-like material feeding device 11, a coating device 12, an emboss roller 13 having an irregular surface, a nip roller 14, a resin-curing device 15, a release roller 16, a protective-film feeding device 17 and a sheet-winding device 18.

The sheet-feeding device 11 as a sheet-like material feeding device feeds a sheet W of a sheet-like material and is composed of a pay-off roll around which the sheet W is wound and so on.

A coating device 12 is a device for applying a liquid containing a radiation curable resin onto the surface of the sheet W, and is composed of a liquid-supplying source 12A for supplying the liquid containing the radiation curable resin; a liquid-supplying device (liquid-supplying pump) 12B; a coating head 12C; a support roller 12D for supporting the sheet W to be coated by winding it, and a pipe which supplies the liquid containing the radiation curable resin from the liquid-supplying source 12A to the coating head 12C. An adopted coating head 12C here is a coating head of a die coater (extrusion coater).

Any well-known drying device 19 can be adopted, as long as it can uniformly dry a coating solution on the sheet W such as a tunnel-shaped drying apparatus shown in FIG. 1. The adoptable drying device includes, for instance, a radiation heating type with the use of a heater, a hot blast circulation type, a far infrared ray type and a vacuum type.

An emboss roller 13 is required to have such a precise pattern of irregularities, mechanical strength and circularity as to be able to transfer and form the irregularities of the roller surface onto the surface of the sheet W. A metallic roller is preferable for such an emboss roller 13.

The emboss roller 13 has a regular pattern of fine irregularities formed on the outer surface. The regular pattern of fine irregularities is required to have a reversed shape of the pattern of fine irregularities to be formed on the surface of an embossed sheet of a product.

The product of the embossed sheet is used, for instance, for a lenticular lens on which the patterns of fine irregularities are two-dimensionally arranged, a fly-eye lens in which the patterns of fine irregularities are three-dimensionally arranged, and a flat lens in which fine cones of a circular cone, pyramid or the like spread in an XY direction, so that a regular pattern of fine irregularities formed on the outer surface of the emboss roller 13 shall correspond to the above pattern.

The adoptable methods for forming the regular pattern of fine irregularities on the outer surface of the emboss roller 13 includes: cutting the surface of the emboss roller 13 with a diamond turning tool (single point); directly forming irregularities on the surface of the emboss roller 13 by photo etching, electron beam lithography and laser machining; and forming irregularities on the surface of a metallic thin sheet by photo etching, electron beam lithography, laser machining or laser beam lithography and then winding the sheet around the roller and fixing it to form the emboss roller 13.

The adoptable method further includes a method of finning irregularities on the surface of a material which is more easily worked than a metal, by photo etching, electron beam lithography, laser machining and laser beam lithography, then forming a metallic thin sheet having the reverse mold of the shape by electroforming, and winding the metallic sheet around the roller and fixing it to form the emboss roller 13. Among them, the method of forming the reverse mold by electroforming has an advantage of obtaining a plurality of the metallic sheets having the same shape from one master (mother).

The surface of the emboss roller 13 is preferably submitted to mold release treatment. Thus mold-release-treated surface of the emboss roller 13 can maintain the shape of the pattern of fine irregularities well. An adoptable mold-release treatment method includes various well-known methods such as fluororesin coating treatment. The emboss roller 13 is preferably provided with drive device. The emboss roller 13 rotates in a counter clockwise direction (CCW) as indicated by an arrow in FIG. 1.

A nip roller 14 is a device which pairs with an emboss roller 13 to roll-form the sheet W while pressing it, and accordingly is required to have predetermined mechanical strength and circularity. The surface part of the nip roller 14 has preferably an appropriate modulus of longitudinal elasticity (Young's modulus) depending on materials and physical properties of the resin and the sheet W. The nip roller 14 is preferably provided with drive device. The nip roller 14 rotates in a clockwise direction (CW) as indicated by an arrow in FIG. 1.

It is preferable to install pressure-applying device to either of the emboss roller 13 and the nip roller 14 in order to apply predetermined pressing force between the emboss roller 13 and the nip roller 14. Similarly, it is preferable to install such fine adjustment device as to be able to precisely control a gap (clearance) between the emboss roller 13 and the nip roller 14, in either of the emboss roller 13 and the nip roller 14.

A resin-curing device 15 is light irradiation device installed so as to face an emboss roller 13 in a downstream side of a nip roller 14. The resin-curing device 15 cures a resin solution layer by irradiating it with light after having made the light pass through a sheet W, accordingly can preferably emit light (radiation) having such a wavelength as to match the curing characteristics of a resin and can emit radiation having such intensity as to match a traveling speed of the sheet W. Adoptable resin-curing device 15 is, for instance, a cylindrical illumination lamp with a length approximately equal to a width of the sheet W. A plurality of the cylindrical illumination lamps can be also arranged in parallel, and a reflecting plate can be also arranged on the back of the cylindrical illumination lamp.

A release roller 16 is a device for releasing the sheet W from an emboss roller 13 while pairing with the emboss roller 13, and accordingly is required to have predetermined mechanical strength and circularity. At a releasing point, the release roller 16 releases the sheet W from the emboss roller 13 while pinching the sheet W wound around the periphery of the emboss roller 13 between the rotating emboss roller 13 and the release roller 16, and winds the sheet W around the release roller 16. In order to ensure the operation, the release roller 16 is preferably provided with drive device. The release roller 16 rotates in a clockwise direction (CW) as indicated by an arrow in FIG. 1.

When a resin or the like raises its temperature by being cured, a release roller 16 can be also provided with a cooling device such as passing cold water through the inside for cooling a sheet W so that the sheet W can be reliably released.

In another adoptable configuration though it is not shown in FIG. 1, a plurality of back-up rollers are installed so as to face an emboss roller 13 between a pressing point (position of 180°) of an emboss roller 13 and a releasing point (position of 0°) on the emboss roller 13 and press a sheet W together with the emboss roller 13, and the coated resin is cured during it.

A sheet-winding device 18 accommodates a released sheet W and is composed of a winding roll for winding up the sheet W. In the sheet-winding device 18, a protective film H is fed onto the surface of the sheet W from adjacently installed a protective-film-feeding device 17, and the sheet-winding device 18 accommodates both films in their overlapping state.

In an apparatus 10 for manufacturing an embossed sheet, a guide roller for forming a path for a sheet W to pass through may be arranged in between a coating device 12 and an emboss roller 13 and in between a release roller 16 and the sheet-winding device 18, and in addition, a tension roller can be arranged in order to take slack during transporting the sheet W as needed.

In the next place, each material applied to the present invention will be described. A usable sheet W includes a resin film, paper (resin coated paper, synthetic paper), a metallic foil (aluminum web) and the like. A usable material of a resin film includes well-known materials such as polyethylene, polypropylene, polyvinyl chloride, polyvinylidene chloride, polyvinyl acetate, polyester, polyolefin, acrylic, polystyrene, polycarbonate, polyamide, PET (polyethylene terephthalate), biaxially-stretched polyethylene terephthalate, polyethylenenaphthalate, polyamide-imide, polyimide, aromatic polyamide, cellulose acylate, cellulose triacetate, cellulose acetate propionate and cellulose diacetate. Among them, polyester, cellulose acylate, acrylic, polycarbonate and polyolefin can be preferably used in particular.

A sheet W to be generally adopted has a width of 0.1 to 3 m, a length of 1,000 to 100,000 m, and a thickness of 1 to 300 μm. However, a sheet W having another size than them may be used.

The sheet W may be previously submitted to corona discharge treatment, plasma treatment, adhesion-facilitating treatment, heat treatment, dust removal treatment or the like. The sheet W preferably has a surface roughness Ra of 3 to 10 nm when a cutoff value is set at 0.25 mm.

In addition, a sheet W to be used may be previously provided with an underlayer such as a dried and cured adhesive layer, or may previously have another functional layer formed on its back face. Similarly, a sheet W composed of not only one layer but also two or more layers can be adopted. In addition, the sheet W is preferably transparent or translucent to pass light through the sheet W.

A resin usable in the present invention contains a compound containing a reactive group such as a (meth)acryloyl group, a vinyl group and an epoxy group, and such a compound as to produce radical or cation active species capable of making the compound containing the reactive group, when irradiated with radiation such as ultraviolet rays.

Particularly, from the viewpoint of a speed to be cured, the resin preferably contains a compound (monomer) containing a reactive group containing an unsaturated group such as a (meth)acryloyl group and a vinyl group in combination with a light radical-polymerization initiator which produces a radical group due to light. Among them, a preferred compound contains a (meth)acryloyl group such as (meth)acrylate, urethane (meth)acrylate, epoxy (meth)acrylate and polyester (meth)acrylate.

A usable compound containing the (meth)acryloyl group includes a compound containing one or more (meth)acryloyl groups. In addition, it is acceptable to singly use the compound (monomer) containing the reactive group containing the above described unsaturated group such as the acryloyl group and the vinyl group, or a plurality of the compounds by mixing them, as needed.

Among compounds containing such a (meth)acryloyl group, a single function-group monomer containing only one (meth)acryloyl group includes, for instance, isobornyl (meth)acrylate, bornyl (meth)acrylate, tricyclodecanyl (meth)acrylate, dicyclopentanyl (meth)acrylate, dicyclopentenyl (meth)acrylate, cyclohexyl (meth)acrylate, benzyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, and methoxypolypropylene glycol (meth)acrylate.

Furthermore, a single function-group monomer having an aromatic ring includes phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenyl phenyl)-2-hydroxypropyl (meth)acrylate, (meth)acrylate of P-cumylphenol reacted with ethylene oxide, 2-bromophenoxyethyl (meth)acrylate, 4-bromophenoxyethyl (meth)acrylate, 2,4-dibromophenoxyethyl (meth)acrylate, 2,6-dibromophenoxyethyl (meth)acrylate, 2,4,6-tribromophenyl (meth)acrylate, and 2,4,6-tribromophenoxyethyl (meth)acrylate.

A commercially available product of such a single function-group monomer having an aromatic ring includes Aronics M113, M110, M101, M102, M5700 and TO-1317 (all manufactured by Toagosei Co., Ltd.); Biscoat #192, #193, 1220 and 3BM (all manufactured by Osaka Organic Chemical Industry Ltd.); NK Ester AMP-110G and AMP-206 (all manufactured by Shin-Nakamura Chemical Co., Ltd.); Light Acrylate PO-A and P-200A, Epoxy Ester M-600A and Light Ester PO (all manufactured by Kyoeisha Chemical Co., Ltd.); and New Frontier PHE, CEA, PHE-2, BR-30, BR-31, BR-31M and BR-32 (all manufactured by Dai-ichi Kogyo Seiyaku Co., Ltd.).

In addition, an unsaturated monomer having two (meth)acryloyl groups in a molecule includes an alkyldiol diacrylate such as 1,4-butanediol diacrylate, 1,6-hexanediol diacrylate and 1,9-nonanediol diacrylate; a polyalkylene glycol diacrylate such as ethylene glycol di(meth)acrylate, tetraethylene glycol diacrylate and tripropylene glycol diacrylate, neopentyl glycol di(meth)acrylate and tricyclodecanemethanol diacrylate.

An unsaturated monomer having a bisphenol skeleton includes ethylene oxide added bisphenol A (meth) acrylic ester, ethylene oxide added tetrabromobisphenol A (meth)acrylic ester, propylene oxide added bisphenol A (meth)acrylic ester, propylene oxide added tetrabromobisphenol A (meth)acrylic ester, bisphenol A epoxy (meth)acrylic ester produced by epoxy ring-opening reaction of bisphenol A diglycidyl ether with (meth)acrylic acid, tetrabromobisphenol A epoxy (meth)acrylate produced by epoxy ring-opening reaction of tetrabromobisphenol A diglycidyl ether with (meth)acrylic acid, bisphenol F epoxy (meth)acrylate produced by epoxy ring-opening reaction of bisphenol F diglycidyl ether with (meth)acrylic acid, and tetrabromobisphenol F epoxy (meth)acrylate produced by epoxy ring-opening reaction of tetrabromo bisphenol F diglycidyl ether with (meth)acrylic acid.

A commercially available product of an unsaturated monomer having such a structure includes Biscoat #700 and #540 (all manufactured by Osaka Organic Chemical Industry Ltd.); Aronics M-208 and M-210 (all manufactured by Toagosei Co., Ltd.); NK Ester BPE-100, BPE-200, BPE-500 and A-BPE-4 (all manufactured by Shin-nakamura Chemical Co., Ltd.); Light Ester BP-4EA and BP-4PA, and Epoxy Ester 3002M, 3002A, 3000M and 3000A (all manufactured by Kyoeisha Chemical Co., Ltd.); KAYARAD R-551 and R-712 (all manufactured by Nippon Kayaku Co., Ltd.); BPE-4, BPE-10 and BR-42M (all manufactured by Dai-ichi Kogyo Seiyaku Co., Ltd); Lipoxy VR-77, VR-60, VR-90, SP-1506, SP-1506, SP-1507, SP-1509 and SP-1563 (all manufactured by Showa Highpolymer Co., Ltd.); and Neopol V779 and Neopol V779MA (manufactured by Japan U-PICA Company, Ltd.).

Furthermore, an unsaturated (meth)acrylate monomer having three or more function groups includes a (meth)acrylate of polyhydric alcohol having three or more valencies such as trimethylolpropane tri(meth)acrylate, pentaerythritol tri(meth)acrylate, trimethylolpropanetrioxyethyl (meth)acrylate and tris(2-acryloyloxyethyl) isocyanurate. A commercially available product includes Aronics M305, M309, M310, M315, M320, M350, M360 and M408 (manufactured by Toagosei Co., Ltd.); Biscoat #295, #300, #360, GPT, 3PA and #400 (all manufactured by Osaka Organic Chemical Industry Ltd.); NK Ester TMPT, A-TMPT, A-TMM-3, A-TMM-3 L and A-TMMT (all manufactured by Shin-nakamura Chemical Co., Ltd.); Light Acrylate TMP-A, TM P-6EO-3A, PE-3A, PE-4A and DPE-6A (all manufactured by Kyoeisha Chemical Co., Ltd.); and KAYARAD PET-30, GPO-303, TMPTA, TPA-320, DPHA, D-310, DPCA-20 and DPCA-60 (all manufactured by Nippon Kayaku Co., Ltd.).

In addition, a compound containing the (meth)acryloyl group may be blended with an oligomer of a urethane (meth)acrylate. The urethane (meth)acrylate includes: a polyether polyol such as polyethylene glycol and polytetramethyl glycol; a polyester polyol produced by a reaction of a dibasic acid such as succinic acid, adipic acid, azelaic acid, sebacic acid, phthalic acid, tetrahydro (anhydrous) phthalic acid and hexahydro (anhydrous) phthalic acid, with a diol such as ethylene glycol, propylene glycol, diethylene glycol, triethylene glycol, tetraethylene glycol, dipropylene glycol, 1,4-butanediol, 1,6-hexanediol and neopentyl glycol; alkyl polyol such as poly-ε-caprolactone denatured polyol; polymethyl valerolactone denatured polyol; ethylene glycol, propylene glycol, 1,4-butanediol, 1,6-hexanediol and neopentyl glycol; bisphenol A skeleton alkylene oxide denatured polyol such as ethylene oxide added bisphenol A and propylene oxide added bisphenol A; bisphenol F skeleton alkylene oxide denatured polyol such as ethylene oxide added bisphenol F and propylene oxide added bisphenol F, or a mixture thereof; an organic polyisocyanate such as tolylene diisocyanate, isophorone diisocyanate, hexamethylene diisocyanate, diphenylmethane diisocyanate and xylylene diisocyanate; and a (meth)acrylate containing a hydroxy group such as 2-hydroxyethyl (meth)acrylate and 2-hydroxypropyl (meth)acrylate. An oligomer of urethane (meth)acrylate is preferable for keeping the viscosity of a curable composition according to the present invention appropriate.

A commercially available monomer of these urethane (meth)acrylates includes, for instance, Aronics M120, M-150, M-156, M-215, M-220, M-225, M-240, M-245 and M-270 (all manufactured by Toagosei Co., Ltd.); AIB, TBA, LA, LTA, STA, Biscoat #155, IBXA, Biscoat #158, #190, #150, #320, HEA, HPA, Biscoat #2000, #2100, DMA, Biscoat #195, #230, #260, #215, #335HP, #310HP, 310HG and #312 (all manufactured by Osaka Organic Chemical Industry Ltd.); Light Acrylate IAA, L-A, S-A, BO-A, EC-A, MTG-A, DMP-A, THF-A, IB-XA, HOA, HOP-A, HOA-MPL and HOA-MPE, Light Acrylate 3EG-A, 4EG-A, 9EG-A, NP-A, 1,6HX-A and DCP-A (all manufactured by Kyoeisha Chemical Co., Ltd.); KAYARADTC-110S, HDDA, NPGDA, TPGDA, PEG 400DA, MANDA, HX-220 and HX-620 (all manufactured by Nippon Kayaku Co., Ltd.); FA-511A, 512A and 513A (all manufactured by Hitachi Chemical Co., Ltd.); VP (manufactured by BASF A.G.); and ACMO, DMAA and DMAPAA (all manufactured by KOHJIN Co., Ltd).

An oligomer of urethane (meth)acrylate is a reactant of (a) a (meth)acrylate containing a hydroxy group, (b) an organic polyisocyanate and (c) a polyol, but is preferably produced by reacting (a) the (meth)acrylate containing the hydroxy group with (b) the organic polyisocyanate and subsequently reacting the reactant with (c) the polyol.

The above described unsaturated monomer may be singly used, or may be used in a mixed form of a plurality of monomers, as needed.

A light radical-polymerization initiator includes, for instance, acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholinopropan-1-one, 2,4,6-trimethylbenzoyldiphenylphosphine oxide, bis-(2,6-dimethoxybenzoyl)-2,4,4-trimethylpentylphosphine oxide, and ethyl-2,4,6-trimethylbenzoylethoxyphenylphosphine oxide.

A commercially available product of a light radical-polymerization initiator includes, for instance, Irgacure 184, 369, 651, 500, 819, 907, 784, 2959, CGI1700, CGI1750, CGI1850 and CG24-61 and Darocur 1116 and 1173 (all manufactured by Ciba Specialty Chemicals); Lucirin LR8728 and 8893X (all manufactured by BASF A.G.); Ubecryl P36 (manufactured by UCB Company); and KIP150 (manufactured by Lanbelty Corporation). Among them, Lucirin LR8893X is preferable because of being a liquid, being easily dissolvable in a solvent and having high sensitivity.

A light radical-polymerization initiator in an amount preferably of 0.01 to 10 wt % and particularly preferably of 0.5 to 7 wt % is blended with respect to all the compositions. An upper limit of an amount to be blended is preferably in the range from the viewpoint of curing characteristics of the composition, mechanical properties and optical characteristics of a cured substance, and the handling easiness of the composition. On the other hand, the lower limit of the amount to be blended is preferably in the range in order to prevent a curing speed from lowering.

A composition according to the present invention can further contain a photosensitizing agent. The photosensitizing agent includes, for instance, triethylamine, diethylamine, N-methyldiethanolamine, ethanolamine, 4-dimethylaminobenzoic acid, 4-dimethyl aminomethyl benzoate, 4-dimethyl ethyl aminobenzoate and 4-dimethylaminobenzoic acid isoamyl. A commercially available product includes, for instance, Ubecryl P102, 103, 104 and 105 (all manufactured by UCB Company).

The composition can still further includes various additives in addition to the above described components, as needed. The various additives includes, for instance, an oxidation inhibitor, an ultraviolet absorber, a light stabilizer, a silane coupling agent, a coated-surface modifier, a heat polymerization inhibitor, a leveling agent, a surfactant, a coloring agent, a preservation stabilizer, a plasticizer, a lubricant, a solvent, a filler, an antioxidant, a wettability modifier and a mold lubricant.

In the above description, the oxidation inhibitor includes, for instance, Irganox 1010, 1035, 1076 and 1222 (all manufactured by Ciba Specialty Chemicals); and Antigen P, 3C, FR and GA-80 (manufactured by Sumitomo Chemical Co., Ltd.). The ultraviolet absorber includes, for instance, Tinuvin P, 234, 320, 326, 327, 328, 329 and 213 (all manufactured by Ciba Specialty Chemicals); and Seesorb 102, 103, 110, 501, 202, 712 and 704 (all manufactured by Shipro Kasei Kaisha, Ltd.). The light stabilizer includes, for instance, Tinuvin 292, 144 and 622LD (all manufactured by Ciba Specialty Chemicals); SanolLS770 (manufactured by Sankyo Co., Ltd.); and Sumisorb TM-061 (manufactured by Sumitomo Chemical Co., Ltd.). The silane coupling agent includes, for instance, γ-aminopropyltriethoxysilane, γ-mercaptopropyltrimethoxysilane and γ-methacryloxypropyltrimethoxysilane. A commercially available product includes SH6062 and 6030 (all manufactured by Dow Corning Toray Co., Ltd.); and KBE 903, 603 and 403 (manufactured by Shin-Etsu Chemical Co., Ltd.). A coated surface modifier includes, for instance, a silicone additive such as dimethylsiloxane polyester and a nonionic fluorosurfactant. A commercially-available product of the silicone additive includes DC-57 and DC-190 (all manufactured by Dow Corning Corporation); SH-28PA, SH-29PA, SH-30PA and SH-190 (all manufactured by Dow Corning Toray Co., Ltd.); KF351, KF352, KF353 and KF354 (all manufactured by Shin-Etsu Chemical Co., Ltd.); and L-700, L-7002, L-7500 and FK-024-90 (all manufactured by Nippon Unicar Co., Ltd.). A commercially available product of the nonionic fluorosurfactant includes FC-430 and FC-171 (all manufactured by 3M Co., Ltd.); and Megafac F-176, F-177, R-08 and F780 (all manufactured by Dainippon Ink & Chemicals, Inc.). The mold lubricant includes Prisurf A208F (manufactured by Dai-ichi Kogyo Seiyaku Co., Ltd.).

The organic solvent for controlling the viscosity of a resin solution according to the present invention may be any solvent that can be mixed with the resin solution without causing ununiformity such as precipitation, phase separation and cloudiness; and includes, for instance, acetone, methyl ethyl ketone, methyl isobutyl ketone, ethanol, propanol, butanol, 2-methoxy ethanol, cyclohexanol, cyclohexane, cyclohexanone and toluene. A mixed liquid of plurality of the above solvents may be used, as needed.

When an organic solvent is added to the resin solution, the organic solvent requires a step of being dried or being evaporated in a production process. When a large amount of the solvent remains in a product even after having been evaporated, the remaining solvent may deteriorate mechanical properties of the product, vaporize and spread while the product is used, emits a bad smell, and adversely affects the health of people in the environment. Accordingly, an organic solvent with a high boiling point is not preferable because of increasing the amount of the remaining solvent.

However, when the solvent has too low boiling point, the solvent may deteriorate the surface state because of rapidly vaporizing, form dew on the surface of a composition due to vaporization heat in a drying step to form a surface defect due to the trace of the dew, and increase vapor density in a production environment to increase the danger of inflammation and the like.

Accordingly, the organic solvent has a boiling point preferably of 50° C. or higher but 150° C. or lower, and more preferably of 70° C. or higher but 120° C. or lower. From the viewpoint of the solubility of a substrate and a boiling point, preferred organic solvents are methyl ethyl ketone (with boiling point of 79.6° C.) and 1-propanol (with boiling point of 97.2° C.).

An amount of an organic solvent to be added to a resin solution according to the present invention is in a range of 10 wt % or more but 40 wt % or less, and preferably is in a range of 15 wt % or more but 30 wt % or less in order to sufficiently improve the coating properties of the mixture, though depending on a type of the solvent and viscosity of the resin solution before being mixed with the solvent. When the amount of the added organic solvent is too small, the organic solvent does not show little effect of lowering the viscosity and increasing the amount of the mixture to be applied, and consequently does not sufficiently improve the coating properties.

However, when a resin solution is too much diluted by a solvent, the mixed liquid tends to flow on the sheet-like material due to too its low viscosity, and consequently causes a problem of causing unevenness on the body and flowing to the back surface of the material. In addition, a large amount of the organic solvent remains in a product because of being not perfectly dried in a drying step, and may deteriorate a function of the product, produce a bad smell by volatilizing while the product is used, and adversely affect health.

A resin solution according to the present invention can be prepared by mixing the above described respective components with a conventional method, through dissolving them by heating as needed. Thus prepared resin solution has the viscosity of normally 10 to 50,000 mPa·s/25° C.

When a resin solution is supplied on a sheet W and an emboss roller 13, a resin solution should not have too high viscosity, because the composition is hardly supplied uniformly, causing coating unevenness, coating waviness and contamination of bubbles while manufacturing a tens, hardly provides the objective thickness of the lens, and can not give the lens sufficient performance.

Particularly when a line speed becomes higher, the above tendency becomes remarkable. Accordingly, in this case, the liquid has preferably low viscosity in a range of preferably 5 to 100 mPa·s and more preferably 10 to 50 mPa·s. Such low viscosity can be obtained by adding a suitable amount of an organic solvent. The viscosity can be also adjusted by keeping a coating solution at a set temperature.

On the other hand, when the viscosity of a resin layer formed after a solvent has vaporized is too low, a thickness of a lens may be hardly controlled when the resin layer is embossed with an emboss roller 13, which may not form a uniform lens with a fixed thickness. Preferred viscosity is 5 to 3,000 mPa·s. When a resin solution is mixed with the organic solvent, if a step of evaporating the organic solvent by heating and drying it is arranged between steps of supplying a resin solution and embossing the dried resin layer with the emboss roller 13, the mixture liquid can be uniformly supplied in a state having low viscosity, and the resin solution in a state of having increased viscosity by evaporating the organic solvent can be uniformly embossed with the emboss roller 13.

When a cured substance obtained by curing a resin solution according to the present invention with radiation is used for a prism lens sheet, it is particularly preferable for the substance to have physical properties (refractive index and softening point) as will be described below.

A refractive index at 25° C. of the cured substance is preferably 1.55 or higher, and further preferably 1.56 or higher. When the refractive index at 25° C. of the cured substance is less than 1.55, a prism lens sheet formed by using the present composition may not reliably develop sufficient front-face brightness.

A softening point is preferably 40° C. or higher and further preferably 50° C. or higher. This is because a cured substance having the softening point of less than 40° C. may not develop sufficient heat resistance.

In the next place, an action of an apparatus 10 for manufacturing an embossed sheet will be described with reference to FIG. 1 again. Sheet-like material feeding device 11 feeds a sheet W at a fixed rate. The sheet W is wound around a first suction drum 24, is absorbed and held by the drum, and is continuously transported.

The sheet W is sent into a coating device 12 which applies a resin solution onto the surface of the sheet W. The coated sheet W is sent to drying device 19 which dries the applied resin solution on the sheet W by evaporating a solvent content.

Subsequently, the sheet W is sent into forming device formed of an emboss roller 13 and a nip roller 14. Then, the rotating emboss roller 13 and nip roller 14 roll-form the continuously traveling sheet W, while pressing it at a position of 180° for the emboss roller 13. In other words, the rotating emboss roller 13 wind the sheet W around it, and transfers the irregularities of the surface of the emboss roller 13 onto a resin layer.

Next, resin-curing device 15 irradiates a resin solution layer on the sheet W in the state of being wound around the emboss roller 13 with radiation. Then, the radiation passes through the sheet W to cure the resin solution layer. Afterwards, a release roller 16 releases the sheet W from the emboss roller 13 while winding the sheet W around the release roller 16 at a position of 180° for the emboss roller 13.

In the above step, the sheet W can be irradiated again with radiation in order to further promote curing after having been released from the emboss roller, though the device is not shown in FIG. 1.

A released sheet W is transported to sheet-winding device 18 which arranges a protective film H supplied from protective-film supplying device 17 on the surface of the sheet W, and a winding roll of the sheet-winding device 18 winds overlapped both films around itself to accommodate them.

Thus, a resin layer is formed on the surface of a sheet W without causing the unevenness of the film thickness, and furthermore, a pattern is stably and uniformly formed on the surface of the sheet W by an emboss roller 13. Thereby, such an embossed sheet can be manufactured as to have a regular pattern of fine irregularities formed on the surface and have high quality free from defects.

In the above description, examples of embodiments on a method and an apparatus for manufacturing an embossed sheet according to the present invention were described, but the present invention is not limited to the examples of the above described embodiments, and can adopt various forms.

For instance, in an example of the present embodiment, a resin solution applied to a sheet W was dried by drying device 19 after having been coated and a specified quantity of a solvent was vaporized, but it is possible to adopt an operational method of not operating the dry device 19 and not vaporizing the solvent of the resin solution applied to the sheet W, as has been already described.

Similarly, it is possible to vaporize a solvent in a resin solution and control a solvent content (solvent concentration) in a resin layer after a sheet W has been released.

In addition, though the form of using a roller-shaped emboss roller 13 was adopted in an example of the present embodiment, the form of using a belt-shaped body such as an endless belt having a pattern of irregularities (embossing shape) on the surface can be also adopted. This is because even such a belt-shaped body works similarly to a cylindrical roller and can provide a similar effect.

In the next place, a method for manufacturing a pattern sheet will be described. A method for manufacturing the pattern sheet adopted in each embodiment of the present invention described below is a modified method of the above described cast imprint method. Specifically, one feature of the method is to reliably provide adequate releasability to a sheet to obtain the pattern thereon, by releasing a pattern-transferred film in a state of containing an organic solvent from a mold for pattern transfer when releasing the pattern-transferred film containing a resin from the mold for pattern transfer. Each embodiment according to the present invention will be described below with reference to the accompanying drawings.

### Second Embodiment

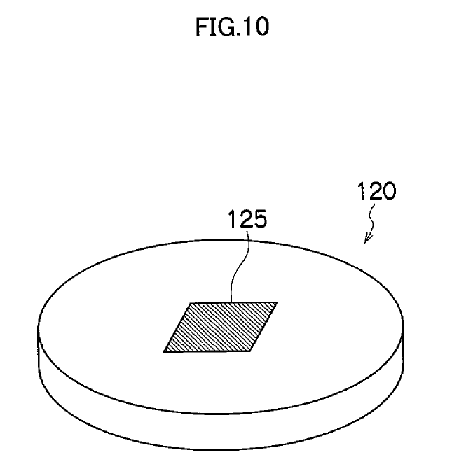

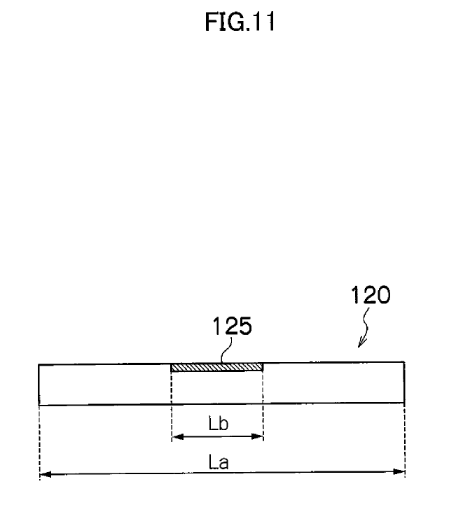

FIG. 10 shows a perspective view of a mold for pattern transfer 120 used in the present embodiment. FIG. 11 shows a sectional view of the mold for pattern transfer 120.

A mold for pattern transfer 120 has a cylindrical form and has a pattern portion for pattern transfer 125 formed on a portion of its surface. On the pattern portion for pattern transfer 125, a predetermined pattern is formed which is a reversed pattern of a fine pattern to be transferred onto a transfer-receiving material. Accordingly, a desired fine pattern is transferred onto the transfer-receiving material when the pattern portion for pattern transfer 125 is pressed to the transfer-receiving material. Such a pattern portion for pattern transfer 125 consists of recesses and salients which constitute a predetermined pattern.

A mold for pattern transfer 120 may be manufactured by any technique as long as it has a predetermined pattern (pattern portion for pattern transfer 125) having an appropriate shape is formed in an appropriate position. Such a mold for pattern transfer 120 of high quality as to have a predetermined pattern accurately formed thereon and have superior releasability can be provided, for instance, by using a Si workpiece which is a Si substrate having the pattern formed thereon with the use of a mask and etching, or using a replica of the Si workpiece replicated by electrocasting. A specific example of components of composing the mold for pattern transfer 120 will be described later.

A mold for pattern transfer 120 and a pattern portion for pattern transfer 125 can be set at an arbitrary size corresponding to a pattern sheet to be manufactured. For instance, it is possible to set a diameter Lₐ of the mold for pattern transfer 120 in a range of about 10 to 16 cm (4 to 6 inches), and set a size L_{b} of one side of the pattern portion for pattern transfer 125 in a range of about 1 to 2 cm. In addition, a depth of the pattern portion for pattern transfer 125 is appropriately adjusted in accordance with a predetermined pattern to be transferred onto a transfer-receiving material.

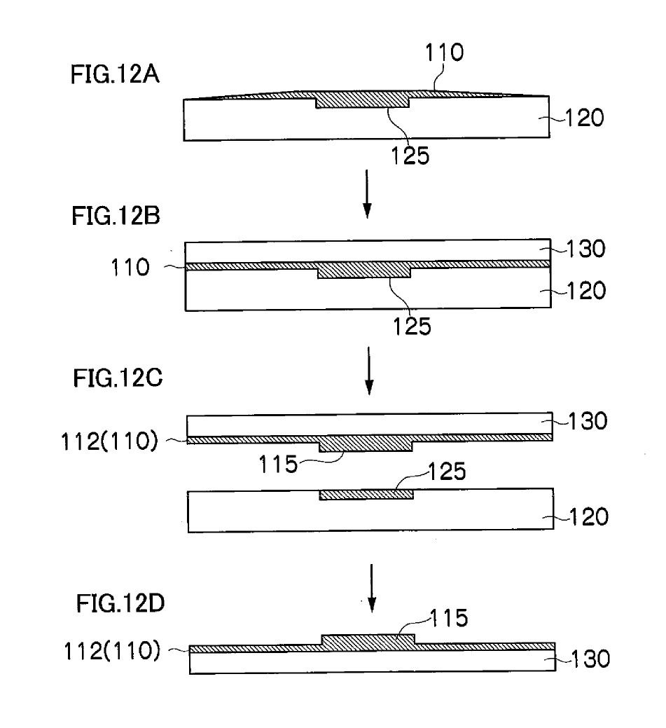

In the next place, a method for manufacturing a pattern sheet will be described. FIGS. 12A to 12D are views showing a process for manufacturing a pattern sheet in a second embodiment.

At first, a transfer-receiving material 110 is applied onto the surface including a pattern portion for pattern transfer 125 of a mold for pattern transfer 120 (see FIG. 12A). The transfer-receiving material 110 is applied onto the mold for pattern transfer 120 so as to form film with a predetermined thickness, and is applied so that the transfer-receiving material 110 sufficiently spreads over the pattern portion for pattern transfer 125.

When the transfer-receiving material 110 is applied onto the mold for pattern transfer 120, it is preferable to decompress at least a periphery of a portion in a mold for pattern transfer 120, onto which the transfer-receiving material 110 is applied. Thereby, the penetration of air is effectively prevented from occurring in a pattern portion for pattern transfer 125, and is also effectively prevented from occurring in the transfer-receiving material 110 when it is applied onto the portion 125. In the above step, an extent of decompression is appropriately adjusted in accordance with a type of the transfer-receiving material 110, an environment and the like. When the transfer-receiving material 110 to be used contains, for instance, an acrylic resin and an acetone solvent, it is preferable to decompress the periphery of the portion onto which the transfer-receiving material 110 is applied into about 5 to 50 kPa.

Alternatively, it is acceptable to bond a substrate 130 on a mold for pattern transfer 120 while pressurizing the substrate, in a step of bonding them. This method can also effectively prevent the penetration of air from occurring in a pattern portion for pattern transfer 125 and a transfer-receiving material 110 when the transfer-receiving material 110 is applied onto the pattern-forming part. In the above step, an extent of the pressure is appropriately adjusted in accordance with a type of the transfer-receiving material 110, but the pressure is preferably about 1 to 5 MPa.

A transfer-receiving material 110 applied to a mold for pattern transfer 120 includes an organic solvent such as acetone and a resin polymer such as an acrylic. A specific example of an organic solvent and a resin polymer composing the transfer-receiving material 110 will be described later.

After a transfer-receiving material 110 has been applied onto a mold for pattern transfer 120, the transfer-receiving material 110 is semi-dried. Dryness for the transfer-receiving material 110 in the above step is determined in accordance with a type of the transfer-receiving material 110 and a fine pattern to be transferred onto the transfer-receiving material 110. The transfer-receiving material 110 is semi-dried preferably so as to vaporize, for instance, 10 to 40% of an initially contained solvent.

Subsequently, a substrate 130 is placed on a transfer-receiving material 110 applied to a mold for pattern transfer 120, and the substrate 130 is bonded to the mold for pattern transfer 120 through the transfer-receiving material 110, in a state that the transfer-receiving material 110 exists between the mold for pattern transfer 120 and the substrate 130 (see FIG. 12B). Thereby, the transfer-receiving material 110 is pressurized by the substrate and enters a pattern portion for pattern transfer 125 without forming a gap, and a predetermined pattern of the mold for pattern transfer 120 is transferred onto a patterned portion 115 on the surface of the transfer-receiving material 110.

In the above step, a substrate 130 preferably includes the same components as the polymer components contained in a transfer-receiving material 110. Thereby, the substrate 130 is effectively bonded to the transfer-receiving material 110, and the transfer-receiving material 110 can be adequately released from a mold for pattern transfer 120, which will be described later. A specific example of the components composing the substrate 130 will be described later.

Afterwards, a transfer-receiving material 110 is held for a predetermined period of time in a state of being sandwiched by a substrate 130 and a mold for pattern transfer 120 to dry a part of the organic solvent contained therein, and when the solvent concentration of the transfer-receiving material 110 reaches a predetermined concentration or lower, the mold for pattern transfer 120 is separated from the substrate 130 (see FIG. 12C). At this time, a pattern-transferred film 112 composed of the transfer-receiving material 110 to which a predetermined pattern of the mold for pattern transfer 120 has been transferred is released from the mold for pattern transfer 120, in a state of adhering to the substrate 130.

When a substrate 130 is separated from a mold for pattern transfer 120, a pattern-transferred film 112 is released from a mold for pattern transfer 120 in a state of containing an organic solvent. At this time, the organic solvent functions as a lubricant and improves slipperiness between the mold for pattern transfer 120 and the pattern-transferred film 112. Thereby, the stress which is applied to the transferred film 112 when being released is dispersed to alleviate stress concentration, so that the pattern-transferred film 112 can be released from the mold for pattern transfer 120 without deteriorating the quality of a patterned portion 115 formed on the pattern-transferred film 112.

A quantity of a solvent contained in a transfer-receiving material 110 when the transfer-receiving material 110 is released from a mold for pattern transfer 120 is adjusted to an appropriate value in accordance with a type and a content ratio of a solvent and a resin polymer contained in the transfer-receiving material 110, a pattern shape, a component of the mold for pattern transfer 120, a component of a substrate 130 and the compatibility of the transfer-receiving material 110 with the mold for pattern transfer 120 or the substrate 130, so that the transfer-receiving material 110 can be adequately released from the mold for pattern transfer 120. The pattern-transferred film 112 can be adequately released from the mold for pattern transfer 120, when the concentration of the organic solvent in the pattern-transferred film 112 reaches, for instance, 5-40% by a weight ratio, and further preferably 20-30% by a weight ratio.

Subsequently, a semi-dry pattern-transferred film 112 on a substrate 130 is further dried to be a product having the pattern-transferred film 112 containing a patterned portion 115, which is used as a pattern sheet (see FIG. 129). The dryness of the pattern-transferred film 112 at this time may be determined in accordance with a type of the pattern-transferred film 112 and a fine pattern transferred onto the pattern-transferred film 112, or the pattern-transferred film 112 may be sufficiently dried unless it does not cause a problem for the product.

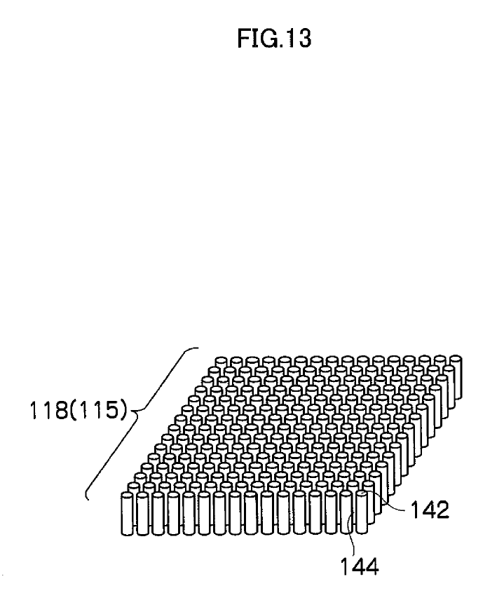

FIG. 13 is a view showing an example of a patterned portion 115 of a pattern-transferred film 112 obtained by passing through a manufacturing process in FIGS. 12A to 12D. In an example shown in FIG. 13, a pillar portion 118 consisting of a plurality of pillars (pillar-shaped parts) is formed on the patterned portion 115. The patterned portion 115 comprises a plurality of pillar salients 142 composed of the pillars and pillar recesses 144 formed among the pillar salients 142. A pattern-transferred film 112 containing the patterned portion 115 having the above configuration is subjected to treatment such as cutting, and is provided as a desired pattern sheet.

As described above, according to the present embodiment, a pattern-transferred film 112 in a state of containing a solvent is released from a mold for pattern transfer 120, so that the pattern-transferred film 112 can be adequately released from the mold for pattern transfer 120.

In addition, a method for manufacturing a pattern sheet on the basis of the present embodiment is particularly effective when a pattern-transferred film 112 is hardly released from a mold for pattern transfer 120, and is also effective in the case of manufacturing the pattern-transferred film 112 (pattern sheet) having a patterned portion 115 having a high aspect ratio expressed by “height/width”, and in the case of manufacturing the pattern-transferred film 112 having the patterned portion 115 having an area of a salient smaller than that of a recess.

Even when a patterned portion 115 transferred onto a pattern-transferred film 112 by a mold for pattern transfer 120 has such a high aspect ratio of a salient as to satisfy, for instance, “height/width ≧2”, the pattern-transferred film 112 can be adequately released from the mold for pattern transfer 120, by using the above described technique shown in FIGS. 12A to 12D according to the present embodiment (see FIG. 12C). Generally, the larger is the aspect ratio, the more difficult it is to release the pattern-transferred film 112 from the mold for pattern transfer 120. Accordingly, the larger is the aspect ratio, the more effectively works the above described technique shown in FIGS. 12A to 12D according to the present embodiment.

In addition, even when a patterned portion 115 transferred onto a pattern-transferred film 112 by a mold for pattern transfer 120 has such an area ratio of a salient to that of a recess as to satisfy “salient area/recess area ≦0.5”, a pattern-transferred film 112 can be adequately released from the mold for pattern transfer 120, by using the above described technique shown in FIGS. 12A to 12D (see FIG. 12C). A heat emboss method or the like generally needs a larger pressure along with the increase of an area to be depressed in a pattern-transferred film 112, because a volume to be deformed increases along with the increase. Accordingly, the smaller is the area of the salient in the patterned portion 115 with respect to that of the recess, the more effectively works the above described technique shown in FIGS. 12A to 12D according to the present embodiment.

### Third Embodiment

In the present embodiment, the same portions as in the above described second embodiment will be denoted by the same reference numerals, and the detailed description thereof will be omitted.

In a second embodiment, an example of applying a transfer-receiving material 110 onto a mold for pattern transfer 120 was described (see FIG. 12A), but in the present embodiment, the example of applying the transfer-receiving material 110 onto a substrate 130 will be described now.

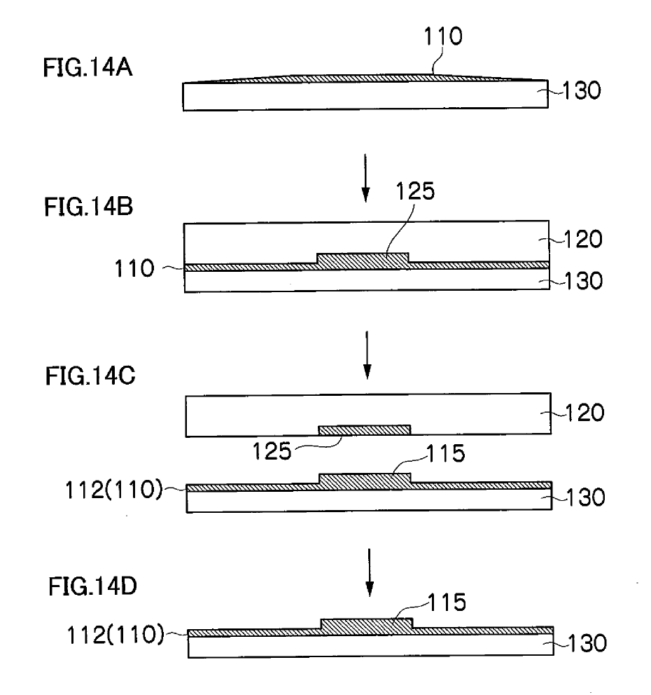

FIGS. 14A to 14D are views showing a process for manufacturing a pattern sheet in a third embodiment. Here, detailed description on the same portions as in the second embodiment will be omitted.

At first, a transfer-receiving material 110 is applied onto a substrate 130 (see FIG. 14A). The transfer-receiving material 110 is applied onto a substrate 130 to form a film with a predetermined thickness so that the transfer-receiving material 110 sufficiently spreads over the pattern portion for pattern transfer 125 of a mold for pattern transfer 120, which will be described later. The transfer-receiving material 110 applied onto the substrate 130 is then semi-dried.

Next, a mold for pattern transfer 120 is placed on a transfer-receiving material 110 which has been applied onto a substrate 130, and is closely contacted with the substrate 130 through the transfer-receiving material 110 (see FIG. 14B), in such a state that the transfer-receiving material 110 exists between the mold for pattern transfer 120 and the substrate 130. Thereby, the transfer-receiving material 110 is pressurized by the mold for pattern transfer 120 and enters a pattern portion for pattern transfer 125 without forming a gap, and a predetermined pattern of the mold for pattern transfer 120 is transferred onto a patterned portion 115 on the surface of the transfer-receiving material 110.

At this time, it is preferable to make a mold for pattern transfer 120 closely contact with a substrate 130 through a transfer-receiving material 110, in such a state that a periphery of the transfer-receiving material 110 is decompressed. Thereby, the penetration of air is effectively prevented from occurring in a pattern portion for pattern transfer 125, and is also effectively prevented from occurring in the transfer-receiving material 110. In the above step, a decompression degree is appropriately adjusted in accordance with a type of the transfer-receiving material 110, an environment and the like. When the transfer-receiving material 110 to be used contains, for instance, an acrylic resin and an acetone solvent, it is preferable to decompress the periphery of the portion onto which the transfer-receiving material 110 is applied into about 5 to 50 kPa.

Then, a transfer-receiving material 110 is held for a predetermined period of time in a state of being sandwiched by a substrate 130 and a mold for pattern transfer 120 to dry a part of the organic solvent contained therein, and when the solvent concentration of the transfer-receiving material 110 reaches a predetermined concentration or lower, the mold for pattern transfer 120 is separated from the substrate 130 (see FIG. 14C). At this time, a pattern-transferred film 112 composed of the transfer-receiving material 110 is released from the mold for pattern transfer 120, in a state of adhering to the substrate 130.

When a mold for pattern transfer 120 is separated from a substrate 130, a pattern-transferred film 112 is released from a mold for pattern transfer 120 in a state of containing an organic solvent. Thereby, the pattern-transferred film 112 can be released from the mold for pattern transfer 120 without deteriorating the quality of a patterned portion 115 in the pattern-transferred film 112.

The quantity of the solvent contained in a pattern-transferred film 112 when it is released from a mold for pattern transfer 120 is the same as in the above described second embodiment.

Subsequently, a semi-dry pattern-transferred film 112 on a substrate 130 is further dried to be a product containing a patterned portion 115, which is used as a pattern sheet (see FIG. 14D).

As described above, according to the present embodiment as well, a pattern-transferred film 112 in a state of containing a solvent is released from a mold for pattern transfer 120, so that the pattern-transferred film 112 can be adequately released from the mold for pattern transfer 120. A method for manufacturing a pattern sheet on the basis of the present embodiment is effective in the case of manufacturing the pattern-transferred film 112 (pattern sheet) having a patterned portion 115 having a high aspect ratio, and in the case of manufacturing the pattern-transferred film 112 having the patterned portion 115 having an area of a salient smaller than that of a recess, which are the same as in a second embodiment.

As described above, a method for manufacturing a pattern sheet according to each embodiment in the present invention is superior in transfer stability and mass productivity, and increases degrees of freedom of a usable material and a pattern shape. In addition, a facility for manufacturing the pattern sheet can be composed of inexpensive machinery and can comparatively easily manufacture the pattern sheet of high quality.

The above described embodiments respectively show one aspect according to the present invention, so that it is possible to add a change such as various design changes based on the knowledge of a person skilled in the art to the embodiment, or to apply a well-known element to the embodiment. The various embodiments to which such a change is added and the embodiments in which devices and methods of embodiments are changed to each other can be included in a range of the present invention.

For instance, a patterned portion 115 described in the above respective embodiments had a pattern of arranging pillars in a lattice form. However, the pattern of the patterned portion 115 is not limited thereby, and may be a fine pattern with another shape as well, which can be obtained by adjusting the predetermined pattern of the pattern portion for pattern transfer 125 of a mold for pattern transfer 120. The manufactured pattern sheet can be used in arbitrary use including a functional material or functional component having a high-aspect-ratio fine pattern like a photonic crystal structure. The pattern sheet manufactured on the basis of the above described respective embodiments is applicable, for instance, to a polarizing film, a biochip, a subminiature sensor, a waveguide and a recording medium.

In the next place, specific components of a transfer-receiving material 110, a mold for pattern transfer 120 and a substrate 130 available in the above described respective embodiments will be described.

An organic solvent available for a transfer-receiving material 110 includes, for instance, MEK, acetone and toluene.

A resin polymer available for a transfer-receiving material 110 includes, for instance, PS (polystyrene), PC (polycarbonate) and acrylic.

A material available for a mold for pattern transfer 120 includes, for instance, Si, quartz and Ni.

A material available for a substrate 130 includes, for instance, PS (polystyrene), PC (polycarbonate), acrylic and PET.

### EXAMPLES

In the next place, the present invention will be described more specifically with reference to examples, but the present invention is not limited to these examples.

### First Example

### Preparation of Resin Solution

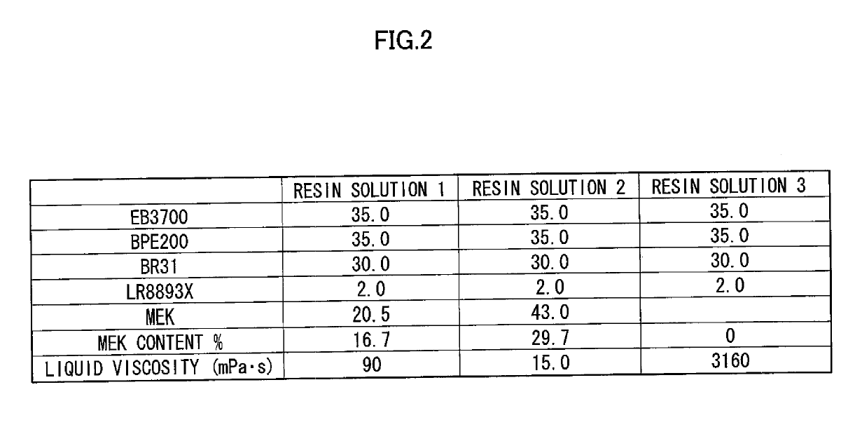

Resin solutions 1-3 were prepared by mixing compounds shown in Table of FIG. 2 at a described weight ratio, heating them to 50° C., and dissolving them while stirring them. Each name and content of the compounds described in the Table are shown below.

EB3700: Ubecryl 3700 manufactured by Daicel-UCB Company Ltd., bisphenol A type epoxy acrylate (with viscosity of 2,200 mPa·s/65° C.);

BPE200: NK Ester BPE-200 manufactured by Shin-nakamura Chemical Corporation, ethylene oxide added bisphenol A methacrylate (with viscosity of 590 mPa·s/25° C.);

BR-31: New Frontier BR-31 manufactured by Dai-ichi Kogyo Seiyaku industry Co., Ltd., tribromophenoxyethyl acrylate (solid at atmospheric temperature with melting point of 50° C. or higher);

LR8893X: Lucirin LR8893X, photoradical generator manufactured by BASF A.G., ethyl-2,4,6-trimethylbenzoylethoxyphenylosphine oxide; and

MEK: methyl ethyl ketone.

### [Manufacture of Embossed Sheet]

An embossed sheet was manufactured with the use of an apparatus 10 for manufacturing an embossed sheet having a configuration shown in FIG. 1.

A used sheet W was a transparent film of PET (polyethylene terephthalate) having a width of 500 mm and a thickness of 100 μm.

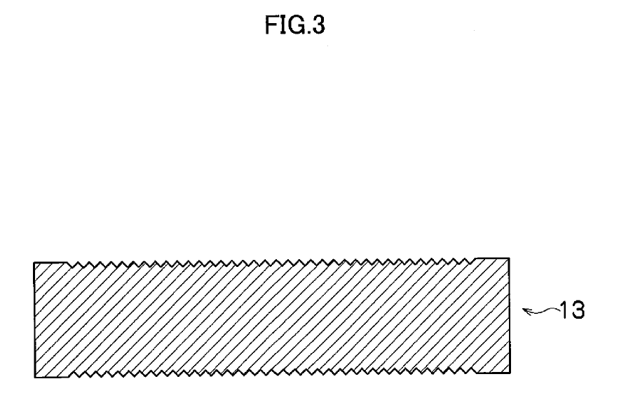

An used emboss roller 13 had the length of 700 mm (width direction of sheet W) and the diameter of 300 mm, was made of S45C, and had a surface part made of nickel. Grooves with the pitch of 50 μm in a roller axial direction were formed on the whole circumference of the surface of a roller having a width of approximately 500 mm, by cutting the surface with a diamond turning tool (single point). A cross-sectional shape of the groove was a triangle shape having the apical angle of 90° at the top and the apical angle of 90° free from a flat part also at the bottom of the groove. Specifically, a groove width was 50 μm and a groove depth was about 25 μm. Because of having grooves free from joint lines and endless in a circumference direction of a roller, the emboss roller 13 can form a lenticular lens (prism sheet) having a triangular cross section on the sheet W. The roller has the surface plated with nickel after having had the groves formed thereon. A schematic cross-sectional view of the emboss roller 13 is shown in FIG. 3.

A die coater was used as a coating device 12. An extrusion type coating head was used for the head 12C of the coating device 12.

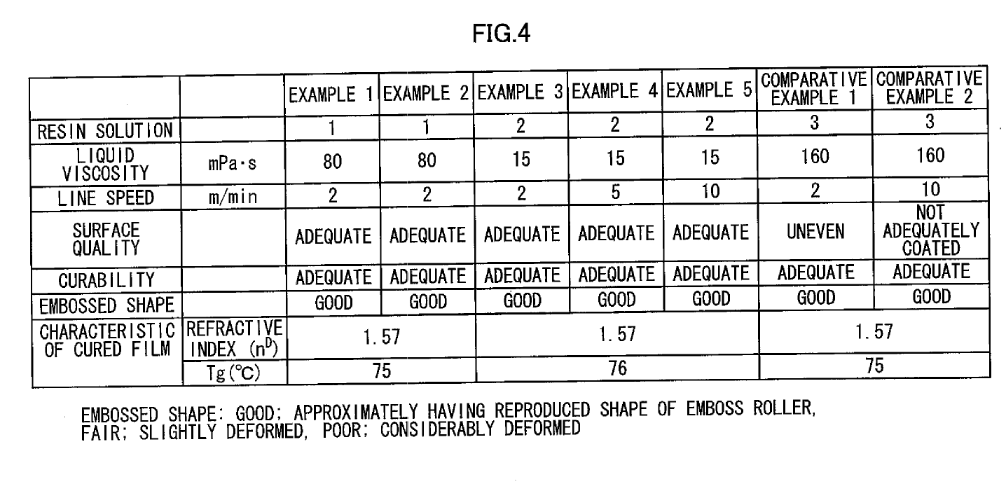

Each liquid described in Table in FIG. 2 was used as a coating solution F (resin solution). Samples for each Example and Comparative Example were manufactured with combination of resin solutions and traveling speeds shown in Table in the following FIG. 4.

The thickness of a coating solution F (resin solution) in a wet condition was controlled by adjusting an amount of the coating solution F supplied to a coating head 12C with a liquid-supplying device (liquid-supplying pump) 12B so that a film thickness after an organic solvent has been dried could be 20 μm.

A hot blast circulation type device was used as a drying device 19. A temperature of a hot blast was set at 100° C.

A used nip roller 14 had a diameter of 200 mm, and had a surface layer formed of silicone rubber having a rubber hardness of 90. A nipping pressure (effective nipping pressure) of pressing a sheet W with an emboss roller 13 and the nip roller 14 was set at 0.5 Pa.

A metal halide lamp was used for resin-curing device 15 and irradiated the resin with light having the energy of 1,000 mJ/cm².

Through the above operations, a sheet W was obtained which had a pattern of irregularities corresponding to each Example and Comparative example shown in Table of FIG. 4 formed thereon.

### [Evaluation for Embossed Shape]

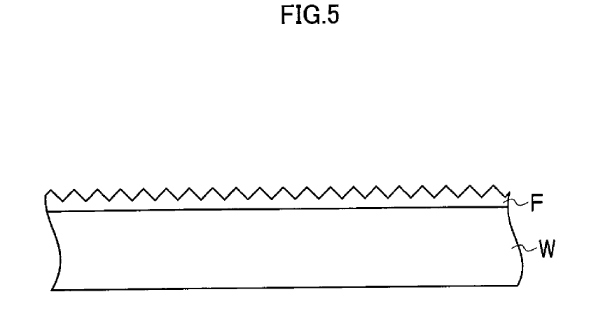

An embossed shape was evaluated by cutting the sheet W and measuring patterns of irregularities in the cross-sectional shapes at a plurality of points with the use of a SEM (scanning electron microscope). The diagrammatic cross-sectional shape of the sheet W (embossed sheet) is shown in FIG. 5.

### [Evaluation for Physical Property of Cured Film]

For each resin solution, an extra cured film was prepared by a method as is shown below and physical properties of the cured film were measured.

### [Measurement of Refractive Index]

A curable liquid composition was applied to a glass plate with the use of a spinner and was dried in an oven set at 100° C. for one minute. The film was irradiated with ultraviolet rays having the intensity of 1,000 mJ/cm² in a nitrogen atmosphere to be converted into a cured film. The refractive index of the cured film was measured at 25° C. with the use of an Abbe's refractometer.

### [Measurement of Tg (Glass Transition Temperature)]

A curable liquid composition was applied to a glass plate with the use of a spinner and was dried in an oven set at 100° C. for one minute. The film was irradiated with ultraviolet rays having the intensity of 1,000 in J/cm² in a nitrogen atmosphere to be converted into a cured film with a film thickness of about 20 μm. The pendulum viscoelasticity of the cured film on the glass plate was measured with a pendulum type viscoelasticity-measuring instrument (model number: DDV-OPA manufactured by Orientec Co., Ltd.) at a heating rate of 5° C./minute, and Tg was determined to be a temperature at which a logarithm attenuation curve shows the maximum value.

A principle of pendulum viscoelasticity measurement is described in general books such as in the paragraph of “evaluation for viscoelasticity of polymer-based composite with rigid body pendulum type viscoelasticity device” in “collection of know-how on thermophysical property and thermal analysis of macromolecule” (first edition), edited by Gijutu Joho Kyokai Co., Ltd., P 287.

Then, each resin solution was applied on a sheet with various traveling speeds in the above described manufacturing method to produce an embossed sheet. A summary of results is shown in Table of FIG. 4. In addition, the refractive index and Tg of a film corresponding to each resin solution were measured on the basis of the above described evaluation method. The summary of the results is also shown in Table of FIG. 4.

When an embossed sheet is produced, applied amounts of the resin solution were adjusted so that each film which forms an embossed shape can have equal thickness after the solvent has been dried. The formed embossed shape were evaluated according to 3 scales of Good for approximately having reproduced shape of emboss roller, Fair for slightly deformed and Poor for considerably deformed as shown in the margin of FIG. 4.

According to Table of FIG. 4, Examples and Comparative Examples did not show any difference of evaluation results on an embossed shape between them. As for the surface quality, however, each Example showed an adequate surface quality, whereas both Comparative Examples 1 and 2 showed a poor surface quality.

From the above described result, it was confirmed that an embossed sheet of high quality free from defects having a regular pattern of fine irregularities formed on the surface can be manufactured without causing the unevenness of a surface quality and affecting physical properties of a cured film at a high line speed with great productivity, by using a resin solution diluted by an organic solvent, which is an advantage according to the present invention.

### Second Example

In the next place, the present invention will be more specifically described with reference to examples, but the present invention is not limited to the examples.

### [Adjustment of Resin Solution, and Manufacture of Embossed Sheet]

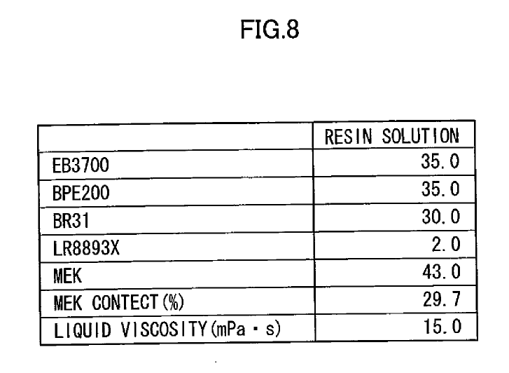

A resin solution (coating liquid) was prepared by mixing chemical compounds shown in Table of FIG. 8 at a described weight ratio, and heating them to 50° C. while stirring the solution to dissolve them. Each name and content of the compounds described in the Table are the same as in the first example. An embossed sheet was manufactured by using the resin solution and an apparatus 10 for manufacturing the embossed sheet having a configuration shown in FIG. 1.

A sheet W used here was a transparent film of PET (polyethylene terephthalate) having a width of 500 mm and a thickness of 100 μm.

An emboss roller 13 used here had the length of 700 mm (in width direction of sheet W) and the diameter of 300 mm, was made of S45C, and coated with nickel on the surface. Grooves with the pitch of 50 μm were formed on the whole circumference over a width of approximately 500 mm in a roller axial direction on the surface of a roller, by cutting the surface with a diamond turning tool (single point). A cross-sectional shape of the groove was a triangle shape having the apical angle of 90° at the top and the apical angle of 90° free from a flat area also at the bottom of the groove. Specifically, a groove width was 50 μm and a groove depth was about 25 μm. Because of having grooves free from joint lines and endless in a circumference direction of a roller, the emboss roller 13 can form a lenticular lens (prism sheet) having a triangular cross section on the sheet W. The roller had the surface plated with nickel after having had the groves formed thereon. A schematic cross-sectional view of the emboss roller 13 is shown in FIG. 3.

A die coater was used as a coating device 12. An extrusion type coating head was used for the head 12C of the coating device 12.

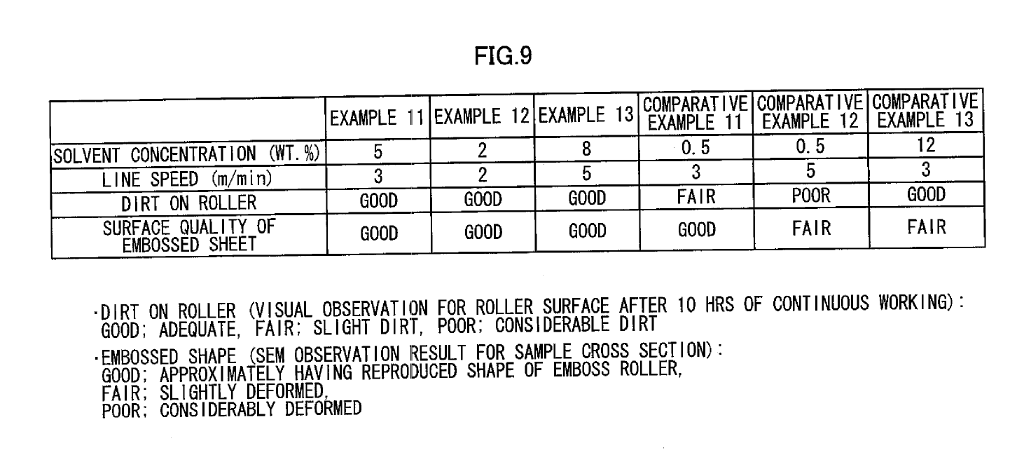

The solution described in the above described Table of FIG. 8 was used as a coating liquid F (resin solution). Then samples for respective Examples and Comparative Examples were manufactured in combined conditions of the solvent concentration in the resin solution and a traveling speed (line speed), as is shown in Table of FIG. 9 which will be described later.

The thickness of a coating liquid F (resin solution) in a wet condition was controlled by adjusting an amount of the coating liquid F supplied to an coating head 12C with a liquid-feeding device (liquid-feeding pump) 12B so that a film thickness after an organic solvent has been dried could be 20 μm.

A hot blast circulation type device was used as a drying device 19. The concentration of a solvent in a coating liquid F was adjusted according to a dry condition (temperature of hot blast) after the liquid had been applied.

A nip roller 14 used here had the diameter of 200 mm, and had the surface layer formed of silicone rubber having a rubber hardness of 90. A nipping pressure (effective nipping pressure) for pressing a sheet W with an emboss roller 13 and the nip roller 14 was set at 0.5 Pa.

A metal halide lamp was used for resin-curing device 15 and irradiated the resin with light having the energy of 1,000 ml/cm².

Through the above operations, a sheet W was obtained which had a pattern of irregularities corresponding to each Example and Comparative Example shown in Table of FIG. 9.

### [Evaluation for Dirt on Emboss Roller]

The surface of an emboss roller 13 was observed by visual inspection after the emboss roller 13 continuously worked for ten hours, and was evaluated in the following way. The surface was evaluated by 3 scale of Good for an adequate state, Fair for a little dirt, and Poor for considerable dirt.

### [Evaluation for Embossed Shape]

An embossed shape was evaluated by the steps of: cutting an obtained sheet W; and observing the cross-sectional shapes of a pattern of irregularities in a plurality of points with the use of a SEM (scanning electron microscope). A diagrammatic cross-sectional shape of the sheet W (embossed sheet) is shown in FIG. 5.

The result was evaluated in the following way. The result was evaluated by 3 scales of Good for the shape which reproduces the surface shape of an emboss roller 13, Fair for a slightly deformed shape, and Poor for a considerably deformed shape. Then, coating liquids F adjusted into several solvent concentrations were applied on a sheet with various traveling speeds in the above described manufacturing method to produce an embossed sheet. The evaluation results are shown in Table of FIG. 9.

According to Table of FIG. 9, all of Examples 11 to 13 which contain 2 to 8 wt. % of a solvent showed adequate evaluation results on the dirt of the emboss roller and on the shape of the embossed sheet.

In contrast to this, Comparative Example 11 which contains 0.5 wt. % of a solvent showed a fair evaluation result on the dirt of an emboss roller and poor over-all evaluation results. Comparative Example 12 which contains 0.5 wt. % of the solvent showed a poor evaluation result on the dirt of the emboss roller, a fair evaluation result an embossed shape and poor over-all evaluation results. Comparative Example 13 which contains 12 wt. % of a solvent showed a fair evaluation result on the embossed shape and poor over-all evaluation results.

From the above described result, it was confirmed that an embossed sheet of high quality free from defects having a regular pattern of fine irregularities free from the unevenness of a surface quality formed on the surface can be manufactured at a high line speed with great productivity by using a method according to the present invention, which is an effect of the present invention.

### Third Example

### Example

In the next place, a specific example based on the present invention will be described. An example described below is performed mainly on the basis of the above described second embodiment, and description on the same content as in the above description will be omitted.

A mold for pattern transfer 120 used here had the following characteristics. Specifically, the mold for pattern transfer 120 had a pattern portion for pattern transfer 125 on which many holes were arranged in a lattice form formed thereon by ion-etching a Si substrate with a diameter of 4 inches with the use of a mask produced by EB lithography (electron beam lithography). Each hole was formed into a diameter of 5 μm and a depth of 30 μm. The pattern portion for pattern transfer 125 was composed of the holes which were arranged with a pitch of 15 μm within the area of 10 mm square into the lattice form.

A transfer-receiving material 110 used here contained an acrylic resin dissolved in acetone of a solvent. As this time, the transfer-receiving material 110 was prepared so that the concentration of the solvent in a solution (solvent/solution) could be 75% by a weight ratio.

An acrylic sheet with a thickness of 100 μm was used as a substrate 130. The substrate 130 had a sufficient size to cover the whole of a pattern portion for pattern transfer 125 in a mold for pattern transfer 120.

In the next place, a process of transferring a fine pattern to a transfer-receiving material 110 (pattern-transferred film 112) by using a pattern portion for pattern transfer 125 of a pattern portion for pattern transfer 125 will be described.

At first, a transfer-receiving material 110 was applied to a mold for pattern transfer 120. A sufficient amount of the transfer-receiving material 110 was uniformly applied onto the mold for pattern transfer 120 by using a so-called “spin coating” method.

When the transfer-receiving material 110 was applied onto a mold for pattern transfer 120, the surface to be coated of the mold for pattern transfer 120 was decompressed to 10 kPa to prevent the penetration of air into the mold for pattern transfer 120.

Then, a substrate 130 was mounted on a transfer-receiving material 110 on a mold for pattern transfer 120 to be contacted with the surface of the transfer-receiving material 110. As this time, the substrate 130 adhered to the transfer-receiving material 110 due to a solvent component in the transfer-receiving material 110.

Then, the mold for pattern transfer 120 and the substrate 130 were held for about one minute in a state of sandwiching the transfer-receiving material between them. While they were held, a part of the solvent in the transfer-receiving material 110 permeated through the substrate 130 and vaporized. As a result, the solvent concentration in the transfer-receiving material 110 sandwiched between the mold for pattern transfer 120 and the substrate 130 became about 25%.

When the solvent concentration reached about 25%, the substrate 130 was separated from the mold for pattern transfer 120. At this time, the pattern-transferred film 112 (transfer-receiving material 110) was released from the mold for pattern transfer 120 together with the substrate 130.

Then, the patterned portion 115 in a pattern-transferred film 112 released from a mold for pattern transfer 120 was dried to vaporize a solvent remaining in the patterned portion 115. Thus formed patterned portion 115 had a pillar portion 118 thereon consisting of a plurality of pillars.

As this time, the pillar portion 118 was formed on the patterned portion 115 in a stable state at a probability of 95% or higher within a range of experiments. Thereby, it was confirmed that a manufacturing method according to the present invention can effectively release a pattern-transferred film 112 from a mold for pattern transfer 120 and provide a pattern sheet of high quality, which is an advantage of the present invention.

### Comparative Example

Against the above described Examples, the following Comparative Example was prepared. The Comparative Example was prepared in the same conditions as in the above described example, except the following conditions.

A solvent concentration in a transfer-receiving material 110 (pattern-transferred film 112) had been adjusted into about 3% when a substrate 130 was separated from a mold for pattern transfer 120. In other words, when the solvent concentration of the transfer-receiving material 110 existing between the mold for pattern transfer 120 and the substrate 130 reached about 3%, the substrate 130 was separated from the mold for pattern transfer 120. In this case, some pillars in a pillar portion 118 of a patterned portion 115 were broken. As a result, an area of the pillars which could be normally prepared was 10% or less of the whole area of the patterned portion 115.

In a next sample, when a solvent concentration of a transfer-receiving material 110 existing between a mold for pattern transfer 120 and a substrate 130 reached about 45%, the substrate 130 was separated from the mold for pattern transfer 120. In this case, almost all transfer-receiving materials 110 remained in the mold for pattern transfer 120.

From these Comparative Examples as well, it was confirmed that a patterned portion 115 keeping an adequate state was manufactured by releasing a pattern-transferred film 112 containing an appropriate amount of an organic solvent from a mold for pattern transfer 120.

1. A method for manufacturing an embossed sheet, in which irregularities on a surface of an emboss roller are formed by transfer on a surface of a sheet-like material, comprising the steps of:
continuously running a flexible strip-shaped sheet-like material, on which a resin solution layer is formed by coating the sheet-like material with a resin solution which is diluted with an organic solvent;
evaporating the organic solvent which is contained in the resin solution layer;
winding the sheet-like material after dried around the emboss roller which is rotating, and then transferring the irregularities of the surface of the emboss roller to the resin solution layer; and
curing the resin solution layer while the sheet-like material is wound around the emboss roller.

2. The method for manufacturing an embossed sheet according to claim 1, wherein
the resin solution is a radiation curable resin solution, and that the resin solution layer is cured by exposing the resin solution layer to a radiation.

3. The method for manufacturing an embossed sheet according to claim 1, wherein
the resin solution contains 10% by weight or more of the organic solvent.

4. The method for manufacturing an embossed sheet according to claim 1, wherein
the resin solution is coated by a die coater, a bar coater, a roll coater, or a gravure coater.

5. The method for manufacturing an embossed sheet according to claim 1, wherein
the resin solution comprises at least the following compounds (A) and (B):
(A) a compound containing a polymerizable group such as an acroyl group and/or a vinyl group; and
(B) a compound which generates an active species capable of polymerizing the compound (A) by radiation exposure.

6. The method for manufacturing an embossed sheet according to claim 1, wherein
the resin solution has a viscosity of 100 mPa·s or less when the solution is coated.

7. A method for manufacturing an embossed sheet, in which irregularities on a surface of an emboss roller are formed by transfer on a surface of a sheet-like material, comprising the steps of:
continuously running a flexible strip-shaped sheet-like material, on which a resin solution layer is formed by coating the material with a resin solution which is diluted with an organic solvent;
winding the sheet-like material around the emboss roller which is rotating, and then transferring the irregularities of the surface of the emboss roller to the resin solution layer in which the organic solvent remains; and
curing the resin solution layer while the sheet-like material is wound around the emboss roller.

8. The method for manufacturing an embossed sheet according to claim 7, wherein
the resin solution is a radiation curable resin solution, and that the resin solution layer is cured by exposing the resin solution layer to a radiation.

9. The method for manufacturing an embossed sheet according to claim 7, wherein
the resin solution layer is cured such a state that the resin solution layer contains 1 to 10% by weight of the organic solvent.

10. The method for manufacturing an embossed sheet according to claim 7, wherein
the concentration of the organic solvent is controlled by evaporating the organic solvent within the resin solution, before winding the sheet-like material around the emboss roller which is rotating.

11. The method for manufacturing an embossed sheet according to claim 7, wherein
the concentration of the organic solvent is controlled by evaporating the organic solvent within the resin solution, after releasing the sheet-like material from the emboss roller.

12. The method for manufacturing an embossed sheet according to claim 7, wherein
an irregular pattern which is formed by transfer on the sheet-like material has a pitch of 100 μm or less.

13. The method for manufacturing an embossed sheet according to claim 7, wherein
the embossed sheet is used as an optical film.

14. An apparatus for manufacturing an embossed sheet, comprising:
a sheet-like material feeding device for feeding a flexible strip-shaped sheet-like material;
a coating device for coating a surface of the sheet-like material with a resin solution which is diluted with an organic solvent;
a drying device for evaporating the organic solvent contained in the resin solution layer;
a transferring device for forming by transfer irregularities of a surface of the emboss roller on the surface of the sheet-like material, while winding the sheet-like material which is continuously running around the emboss roller which is rotating; and
a resin solution curing device for curing the resin solution while the sheet-like material is wound around the emboss roller.

15. An apparatus for manufacturing an embossed sheet, comprising:
a sheet-like material feeding device for feeding a flexible strip-shaped sheet-like material;
a coating device for coating a surface of the sheet-like material with a resin solution which is diluted with an organic solvent;
a first drying device for evaporating the organic solvent contained in the resin solution layer;
a transferring device for forming by transfer irregularities of a surface of the emboss roller on the surface of the sheet-like material, while winding the sheet-like material which is continuously running around the emboss roller which is rotating;
a resin solution curing device for curing the resin solution while the sheet-like material is wound around the emboss roller; and
a second drying device for evaporating the organic solvent contained in the resin solution layer after the layer is cured.

16. The apparatus for manufacturing an embossed sheet according to claim 14, wherein
the resin solution curing device is irradiation device which is provided in proximity to the emboss roller.

17. A method for manufacturing a patterned sheet which has fine patterns, comprising the steps of:
in a situation in which a transfer-receiving material containing an organic solvent and a resin polymer is interposed between a mold for pattern transfer having a predetermined pattern formed thereon and a substrate, bringing the mold for pattern transfer into close contact with the substrate via the transfer-receiving material;
evaporating a portion of the organic solvent which is contained in the transfer-receiving material between the mold for pattern transfer and the substrate; and
releasing a transferred film from the mold for pattern transfer, the transferred film being made of the transfer-receiving material on which fine patterns are formed by transferring the predetermined pattern of the mold for pattern transfer,
wherein, in a case of releasing the transferred film from the mold for pattern transfer, the transferred film which contains the organic solvent is released from the mold for pattern transfer.

18. The method for manufacturing the patterned sheet according to claim 17, wherein,
the concentration of the organic solvent within the transferred film is 5 to 40% by weight ratio when the transferred film is released from the mold for pattern transfer.

19. The method for manufacturing the patterned sheet according to claim 17, wherein
at least one of polymers included in the substrate is soluble in the organic solvent.

20. The method for manufacturing the patterned sheet according to claim 17, wherein
the transfer-receiving material is interposed between the mold for pattern transfer and the substrate, by coating at least either one of the mold for pattern transfer and the substrate with the transfer-receiving material.

21. The method for manufacturing the patterned sheet according to claim 17, in which the transfer-receiving material is interposed between the mold for pattern transfer and the substrate by coating the mold for pattern transfer with the transfer-receiving material, wherein,
at least a periphery of an area on which the transfer-receiving material is coated among the mold for pattern transfer is depressurized when the mold for pattern transfer is coated with the transfer-receiving material.

22. The method for manufacturing the patterned sheet according to claim 17, in which the transfer-receiving material is interposed between the mold for pattern transfer and the substrate by coating the substrate with the transfer-receiving material, wherein
at least a periphery of the transfer-receiving material is depressurized when the mold for pattern transfer is brought into close contact with the substrate via the transfer-receiving material.

23. The method for manufacturing the patterned sheet according to claim 17, in which the transfer-receiving material is interposed between the mold for pattern transfer and the substrate by coating the substrate with the transfer-receiving material, wherein
the mold for pattern transfer is brought into close contact with the substrate via the transfer-receiving material while keeping them with a pressure applied thereon.

24. The method for manufacturing the patterned sheet according to claim 17, wherein
the mold for pattern transfer is a Si workpiece which is derived from a Si substrate processed by using a mask and an etching treatment, or is a replica which is derived from the Si workpiece subjected to electroforming.

25. The method for manufacturing the patterned sheet according to claim 17, wherein
an aspect ratio of a salient of the fine pattern which is formed on the transferred film satisfies the following relational expression: Height/Width ≧2.

26. The method for manufacturing the patterned sheet according to claim 17, wherein
an area ratio of a salient to a recess of the fine pattern formed on the transferred film satisfies the following relational expression: an area of salient/an area of recess ≦0.5.

27. A patterned sheet, wherein the patterned sheet is manufactured in accordance with the method for manufacturing the patterned sheet according to claim 17.
